(19) United States
(12) Patent Application Publication
(10) Pub. No.: US 2019/0182007 A1
(43) Pub. Date: Jun. 13, 2019

(54) METHOD OF WIRELESS COMMUNICATION AND USER EQUIPMENT

(71) Applicants: DOCOMO INNOVATION, INC., Palo Alto, CA (US); NTT DOCOMO, INC., Tokyo (JP)

(72) Inventors: Le Liu, Tokyo (JP); Yuichi Kakishima, Tokyo (JP); Haralabos Papadopoulos, Tokyo (JP)

(73) Assignee: NTT DOCOMO, INC., Tokyo (JP)

(21) Appl. No.: 16/324,868

(22) PCT Filed: Aug. 11, 2017
(86) PCT No.: PCT/US2017/046479

§ 371 Date: Feb. 11, 2019

Related U.S. Application Data
(60) Provisional application No. 62/373,774, filed on Aug. 11, 2016.

(51) Int. Cl. H04L 5/00

(52) U.S. Cl. CPC H04L 5/0048

(57) ABSTRACT

A method for wireless communication includes transmitting, from a base station (BS) to a user equipment (UE), a Channel State Information Reference Signal (CSI-RS). The CSI RS is quasi-orthogonally or non-orthogonally multiplexed on multiple resource elements (REs). The BS transmits multiple CSI-RSs to the UE and the multiple CSI-RSs are multiplexed on a same RE. The method further includes applying, with the BS, different transmission power to the multiple REs, and notifying, with the BS, the UE of transmission power information that indicates values of the applied different transmission power. The method further includes scrambling, with the BS, the multiple REs with a predetermined scrambling sequence and notifying, with the BS, the UE of scrambling sequence information that indicates predetermined scrambling sequence.

The present invention generally relates to a method of multiplexing downlink reference signal such as a Channel State Information-Reference Signal (CSI-RS) in a wireless communication system.

### BACKGROUND ART

Dense cellular network deployments relying on the use of Massive Multi-Input-Multi-Output (MIMO) (M-MIMO) technology are becoming very attractive candidates for future radio access technologies. This is partly due to the promise of Massive MIMO for providing very large throughput increases per BS, due to its ability to multiplex a large number of high-rate streams over each transmission resource element.

It is well accepted by now that major gains in the physical (PHY) layer in terms of throughput per unit area are to come from the judicious use of dense infrastructure antenna deployments, comprising of a dense network of small cells, possibly equipped with large antenna arrays. Indeed, Massive MIMO is very attractive when it is used over dense (small cell) deployments, as, in principle, it can translate to massive throughput increases per unit area with respect to existing deployments.

Massive MIMO is also envisioned as a candidate for addressing large variations in user load, including effectively serving user-traffic hotspots spots, such as e.g., malls or overcrowded squares. A deployment option that is considered attractive (especially) for serving user-traffic hotspots involves remote radio-head (RRH) systems in which a base station (BS) controls a massive set of antennas that are distributed over many locations. Current proposals for RRH systems consider only one or at most a few antennas per RRH site. However, with bandwidth expected to become available at higher frequency bands (including in the mmWave band), it will become possible to space antenna elements far closer to one another and consider RRHs with possibly a large number of antennas per RRH site. In principle this would allow the network to simultaneously harvest densification and large-antenna array benefits thereby delivering large spectral efficiencies per unit area.

A heterogeneous network is illustrated in FIG. 1, where the RRHs in the left figure are deployed in 4G LTE using 3.5 GHz bands to serve user equipments (UEs) or user equipments (UEs) in several hotspots within the Macro cell coverage. When the RRHs in the right figure are deployed in a New Radio (NR) system using the spectrum at higher carrier frequency, such as mmWave bands, the propagation is hostile and the free-space propagation loss is higher and the diffraction losses as well as the penetration losses are higher. All these significant propagation losses will reduce the original coverage of each RRH in the lower frequency bands. However, higher frequencies also offer opportunities, since the antenna elements get smaller. It becomes possible to pack more elements into a smaller antenna. For example, a state-of-the-art antenna for 2.6 GHz is roughly one meter tall, and contains 20 elements. At 15 GHz, it is possible to design an antenna with 200 elements that is only 5 cm wide and 20 cm tall. With more antenna elements, it becomes possible to steer the transmission towards the intended receiver. Therefore, the Massive MIMO per RRH is used to concentrate the transmission in a certain direction so that the coverage is significantly improved. If a RRH transmitter is equipped with a very large number of transmit antennas (e.g., 32, 62, or 100) that can be used simultaneously for transmission to multiple UEs with much less number of the receive antennas (e.g., 1, 2, 4, etc.).

Clearly, as higher band frequencies become available and wireless network become increasingly densified, there is a need for methods that allow translating antenna/site-densification into gains in spectral-efficiency per unit area. The spatial beams generated by massive MIMO can be regarded as beam cells and the simultaneous transmission from the beam cells to multiple UEs can boost the system throughput as expected. However, for a well-planned cellular network the operation, in the case that the cell location and cell coverage as well as the number of cells remain fixed, achieving similar gains with network densification (i.e., in cases where both the number of beams/cells increase and their coverage is configurable, is not possible with the current state-of-the-art methods.

In the LTE downlink, five different types of RS are provided:
Cell-specific RSs (often referred to as ‘common’ RSs, as they are available to all UEs in a cell and no UE-specific processing is applied to them);
UE-specific RSs, also known as DeModulation Reference Signals (DM-RSs) (introduced in Release 8, and extended in Releases 9 and 10), which may be embedded in the data for specific UEs;
MBSFN-specific RSs, which are used only for Multimedia Broadcast Single Frequency Network (MBSFN) operation;
Positioning RSs, which from Release 9 onwards may be embedded in certain ‘positioning subframes’ for the purpose of UE location measurements;
CSI-RSs, which are introduced in Release 10 specifically for the purpose of estimating the downlink channel state and not for data demodulation.

Each RS pattern is transmitted from an antenna port at the eNB. An antenna port may in practice be implemented either as a single physical transmit antenna, or as a combination of multiple physical antenna elements. The transmit RS corresponding to a given antenna port defines the antenna port form the point of view of the UT, and enables the UT to derive a channel estimate for all data transmitted or generate CSI feedback on the antenna port regardless of whether it represents a single radio channel from one physical antenna or a composite channel from a multiplicity of physical antenna elements together comprising the antenna port. The designation of the antenna ports available in LTE are summarized below:
Antenna ports 0-3: Cell-specific RS
Antenna port 4: MBSFN
Antenna port 5; DM-RS for single-layer beamforming
Antenna port 6: positioning RSs (introduced in Release 9)
Antenna ports 7-8: DM-RSs for dual-layer beamforming (introduced in Release 9)
Antenna ports 9-14: DM-RSs for multi-layer beamforming (introduced in Release 10)
Antenna ports 15-22: CSI-RSs (introduced in Release 10)

The text that follows provides a brief description of the downlink reference signal (DL RS) used for Channel State Information (CSI) measurement in current cellular LTE systems. A UT measures the downlink channel from an eNB transmitter to the UT receiver using downlink RS and reports CSI measurement in the uplink. LTE Release 8 provides CRS for up to 4 antenna ports. CRSs are used by UEs both to perform channel estimation for demodulation of data and to derive feedback on the quality and spatial properties of the downlink radio channel. CRS is sent in every subframe for radio resource management (RRM) measurement. Normally, CRS is broadcasting with no precoding at the eNB side and no user-specific processing is applied. CSI-RS is introduced in LTE Release 10, especially for the purpose of estimating downlink CSI and not for data transmission. CSI-RS is more flexible with network configuration to support up to 8 antenna ports.

The main goal of CSI-RSs is to obtain channel state feedback for up to eight transmit antenna ports to assist the eNodeB in its precoding operations. Release 10 supports transmission of CSI-RS for 1, 2, 4 and 8 transmit antenna ports. CSI-RSs also enable the UE to estimate the CSI for multiple cells rather than just its serving cell, to support future multicell cooperative transmission schemes. CSI-RSs of different antenna ports within a cell, and, as far as possible, from different cells, should be orthogonally multiplexed to enable accurate CSI estimation.

Release 13 extends the transmission of CSI-RS for 12, 16 transmit antenna ports based on orthogonal CDM (code division multiplexing) transmission. Correspondingly, the CSI-RSs are transmitted on 1/2/4/8/12/16 antenna ports using p=15, p=15,16, p=15, . . . , 18, p=15, . . . , 22, p=15, . . . , 26 and p=15, . . . , 30, respectively. For CSI-RSs using more than 8 antenna ports, Nᵣₑₛ^{CSI}>1 CSI-RS configurations in the same subframe, numbered from 0 to Nᵣₑₛ^{CSI}−1, are aggregated to obtain Nᵣₑₛ^{CSI}Nₚₒᵣₜₛ^{CSI} antenna ports in total, where the number of antenna ports per CSI-RS configuration Nₚₒᵣₜₛ^{CSI} is equal to 4 or 8 if the number of CSI-RS configurations Nᵣₑₛ^{CSI}=3 or 2, respectively. The mapping depends on the higher-layer parameter CDMType (type of code division multiplexing), where different orthogonal 2×2 or 4×4 Hadamard codes are used for CDMType=CDM2 or CDM4 respectively. The higher-layer parameter CSI-RS configuration informs the resource elements (k,l) in the k-th subcarrier and 1-th OFDM symbol used for CSI-RS transmission on any of the antenna ports in the set S, where S={15} if CDMType is not configured, or S={15,16}, S={17,18}, S=119,201, S={21,22} in case of CDMType=CDM2, or S={15,16,17,18}, S={19,20,21,22}, S={23,24,25,26} for CSI reference signals on 12 ports in case of CDMType=CDM4, or S={15,16,19,20}, S={17,18,21,22}, S={23,24,27,28} or S={25,26,29,30} for CSI reference signals on 16 ports in case of CDMType=CDM4.

The CSI-RS sequence mapped to each CSI-RS pattern in a cell is generated by a pseudo-random sequence generator as a function of the cell ID in the cell. In Rel. 10 the cell ID is not explicitly signaled by the eNB but is implicitly derived by the UT as a function of the primary synchronization signal (PSS) and secondary synchronization signal (SSS). To connect to a wireless network, the UT performs downlink cell search to synchronize to the strongest cell. Cell search is performed by blindly detecting the PSS/SSS of each cell and comparing the receive power strength of different cells. After cell search is successfully performed, the UT establishes connection to the strongest cell and derives the cell ID from the PSS/SSS.

In the frequency domain, CSI-RS is uniformly spaced in each resource block. In the time domain, the number of subframes containing CSI-RS is minimized to tradeoff between accurate CSI estimation and the overall overhead as well as the efficient operation and minimizing the impact on legacy pre-Release 10 UEs which are unaware of the presence of CSI-RS and whose data is punctured by the CSI-RS transmission. Also, the CSI-RS should avoid the resource elements used for cell-specific RS (CRS) and control channel (PDCCH), as well as the avoiding resource elements used for UE-specific dedicated RSs (DRS) or demodulated RS (DM-RS).

In LTE Release 10, the CSI-RSs are transmitted on one, two, four or eight antenna ports using p=15, p=15,16, p=15, . . . , 18 and p=15, . . . , 22, respectively, as shown in FIG. 2A, where each pattern of CSI-RS represents to a CSI-RS configuration and the index 0-7 corresponds to the CSI-RS port index 15-22 respectively. In case of CDMType=2, the CDM codes of length 2 are used, so that CSI-RSs on two antenna ports share two REs on a given subcarrier. There are 5/10/20 CSI-RS configurations in case of 8/4/2 CSI-RS ports, respectively. Although the CSI-RSs in LTE Release 13 can support up to 16 antenna ports but more than 8 antenna ports are multiplexed by using CDM. Equivalently, each cell can only use one CSI-RS configuration and the CSI-RS density is one orthogonal per RB per antenna port. In case of CSI-RS configuration 0, CSI-RS Resource Unit (RU) allocation for each CSI-RS port is shown in FIGS. 2B and 2C.

The CSI-RS configuration in LTE Rel. 10 is based on the single-cell framework. When configured, CSI-RSs are present only in some specific subframes following a given duty cycle and subframe offset. The duty cycle and offset of the subframes containing CSI-RSs and the CSI-RS pattern used in those subframes are provided to a Release 10 UE through RRC signaling. The following parameters for CSI-RS are explicitly configured via semi-static radio resource control (RRC) higher-layer signaling for each UT, including the following parameters Nt, Ni, Np, Noffset and α. Nt is the number of CSI-RS antenna ports. In LTE Rel. 10 the number of antenna ports can be 1, 2, 4 or 8. Ni is the CSI-RS pattern index corresponding to a certain CSI-RS pattern, based on the number of CSI-RS antenna ports. Np is the duty cycle or periodicity of CSI-RS transmission. For Np=5 the CSI-RS is transmitted every 5 subframes. In LTE each subframe is 1 ms in duration. Noffset is the subframe offset. The duty cycle and subframe offset are jointly encoded in LTE Rel. 10 and signaled to a UT via the downlink subframes that contain CSI-RS. The parameter α is used to control UT assumption on reference PDSCH transmitted power for CSI feedback.

The multiplexing of the LTE CSI-RS is orthogonal resources based on TDM/FDM/CDM. However, for the Massive MIMO communication systems, current LTE CSI-RS cannot to support the CSI-RS for a large number of beams/streams (>16 streams) on the limited resources (e.g., antenna ports). Extending the antenna ports on orthogonal resources is not desirable, because it will sacrifice the resources for the data transmission, resulting in larger overhead and lower system throughput.

### CITATION LIST

[Non-Patent Reference 1] TS36.211 V13.0.0

### SUMMARY OF THE INVENTION

One or more embodiments of the present invention may address the above-mentioned issues and may provide the advantages described below. Accordingly, an aspect of the present invention is to provide a method for transmitting a Channel State Information Reference Signal (CSI-RS) that is capable of improving resource management efficiency of an evolved NodeB (eNB) or RRH with massive MIMO as well as the channel measurement efficiency of a user equipment (UE).

In accordance with one or more embodiments of the present invention, a method for transmitting a CSI-RS in an orthogonal frequency division multiplexing (OFDM)-based system is provided for the sake of good backward compatibility to the CSI-RS transmission in the LTE systems. The method includes determining a CSI-RS pattern for multiple overlapped and non-overlapped beams in a physical resource block (PRB) of a subframe, assigning, when the configured PRBs in the configured subframe is supposed to carry the CSI-RS. The CSI-RSs for a large number of beams are multiplexed over the conventional 1/2/4/8/12/16 CSI-RS antenna ports with no more additional resources but applying beam-specific CSI-RS pattern on the CSI-RS RU, where the RU could be a RB with CSI-RS transmitted or one or more resource elements on the CSI-RS antenna port set S, where S={15} if CDMType is not configured, or S={15,16}, S={17,18}, S={19,20}, S={21,22} in case of CDMType=CDM2, or S={15,16,17,18}, S={19,20,21,22}, S={23,24,25,26} for CSI reference signals on 12 ports in case of CDMType=CDM4, or S={15,16,19,20}, S={17,18,21,22}, S={23,24,27,28} or S={25,26,29,30} for CSI reference signals on 16 ports in case of CDMType=CDM4

In accordance with one or more embodiments of the present invention, a method is to design the CSI-RS patterns for multiple virtual beam cells. Those virtual beam cells share the same cell identification (ID) so that the detailed configuration of those beam cells is transparent to the UEs. The non-overlapped (spatially orthogonal) virtual beam cells are grouped together and the overlapped (spatially non-orthogonal) virtual beam cells are divided into different groups. Only the virtual beam cells within one group are transmitting CSI-RS on the same CSI-RS resource element(s) (RE(s)); while those in different group are sending CSI-RS on orthogonal CSI-RS REs. Each CSI-RS sharing the same REs is identified by a unique beam pattern or beam index, which is easily detected at the UT receiver side. If a UT is within the coverage of a virtual beam cell, it will identify the corresponding beam pattern based on the CSI-RS pattern detection and feedback the corresponding beam index to inform the network the UT-selected virtual beam cell.

According to one or more embodiments of the present invention, a method for wireless communication includes transmitting, from a BS to a UE, a CSI-RS. The CSI-RS may be quasi-orthogonally or non-orthogonally multiplexed on multiple resource elements (REs).

According to one or more embodiments of the present invention, a UE includes a receiver that receives, from a BS, multiplexing information and multiple CSI-RSs using different beams, and a processor that detects at least one beam of the different beams based on the multiplexing information. The multiple CSI-RSs are quasi-orthogonally or non-orthogonally multiplexed on multiple REs. The multiplexing information indicates a quasi-orthogonal multiplexing method or a non-orthogonal multiplexing method used for multiplexing the multiple CSI-RSs.

According to one or more embodiments of the present invention, a UE includes a processor that detects, based on multiplexing information transmitted from a BS, at least one beam of different beams used for multiple CSI-RSs transmission, and a transmitter that transmits, to the BS, feedback information that indicates the detected beam. The multiple CSI-RSs are quasi-orthogonally or non-orthogonally multiplexed on multiple REs. The multiplexing information indicates a quasi-orthogonal multiplexing method or a non-orthogonal multiplexing method used for multiplexing the multiple CSI-RSs.

### BRIEF DESCRIPTION OF THE DRAWINGS

FIG. 1 is a diagram showing a configuration of a Massive MIMO systems in HetNet.

FIG. 2A is a diagram showing resource elements (REs) allocated to the CSI-RS antenna ports in a resource block (RB) according to one or more embodiments of the present invention.

FIGS. 2B and 2C are diagrams showing configurations of mapping of CSI reference signals (CSI configuration 0, normal cyclic prefix).

FIG. 3 is a diagram showing a configuration of a wireless communication system according to one or more embodiments of the present invention.

FIGS. 4A-4C are diagrams showing virtual beam cells according to one or more embodiments of the present invention.

FIG. 5A is a diagram showing a diagram showing a CSI-RS pattern with 4 groups and 4 beams per group on 4 CSI-RS ports according to one or more embodiments of the present invention.

FIG. 5B is a diagram showing a diagram showing a CSI-RS pattern with 8 groups and 2 beams per group on 8 CSI-RS ports according to one or more embodiments of the present invention.

FIGS. 6A-6C are diagrams showing beam-specific CSI-RS patterns according to one or more embodiments of a first example of the present invention.

FIG. 7 is a table showing beam-specific CSI-RS patterns for a group of orthogonal beams based on 0/1 binary power level setting according to one or more embodiments of the first example of the present invention.

FIG. 8 is a diagram showing a CSI-RS configuration with normal cyclic prefix according to one or more embodiments of the first example of the present invention.

FIG. 9A is a diagram showing an example of CSI-RS1 for beam selection and CSI-RS2 for CSI measurement according to one or more embodiments of the first example of the present invention.

FIG. 9B is a diagram showing an example where different periodicity is applied to NZP/ZP-CSI-RS RUs according to one or more embodiments of the first example of the present invention.

FIGS. 10A and 10B are diagrams showing examples of beam-specific CSI-RS pattern detection according to one or more embodiments of the first example of the present invention.

FIG. 11 is a diagram showing an example of a beam switch based on a beam-specific CSI-RS pattern according to one or more embodiments of the first example of the present invention.

FIG. 12 is a sequence diagram showing an example operation of the beam switch according to one or more embodiments of the first example of the present invention.

FIG. 13 is a diagram showing an example of a beam-specific CSI-RS pattern according to one or more embodiments of a second example of the present invention.

FIGS. 14A and 14B are diagrams showing examples of beam-specific CSI-RS pattern detection according to one or more embodiments of the second example of the present invention.

FIG. 15 is a diagram showing an example of a beam switch based on a beam-specific CSI-RS pattern according to one or more embodiments of the second example of the present invention.

FIG. 16 is a sequence diagram showing an example operation of the beam switch according to one or more embodiments of the second example of the present invention.

### DETAILED DESCRIPTION OF EMBODIMENTS

Embodiments of the present invention will be described in detail below, with reference to the drawings. In embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid obscuring the invention.

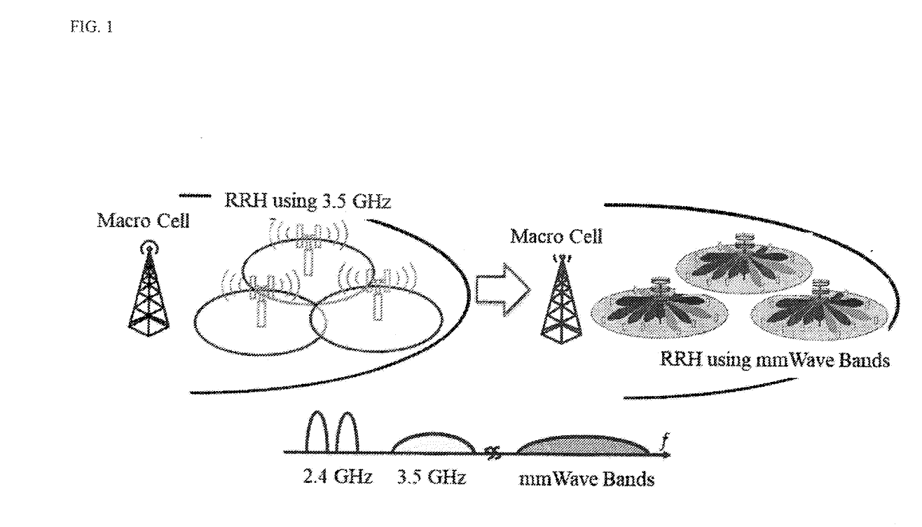

FIG. 1 is a wireless communications system 1 according to one or more embodiments of the present invention. The wireless communication system 1 includes a user equipment (UE) 10, a base station 20 (e.g., gNodeB (gNB) or RRH), and a core network 30. The wireless communication system 1 may be a New Radio (NR) system. The wireless communication system 1 is not limited to the specific configurations described herein and may be any type of wireless communication system such as an LTE/LTE-Advanced (LTE-A) system.

The BS 20 may communicate uplink (UL) and downlink (DL) signals with the UE 10 in a cell of the BS 20. The DL and UL signals may include control information and user data. The BS 20 may communicate DL and UL signals with the core network 30 through backhaul links 31. The BS 20 may be an example of a base station (BS). The BS 20 may be referred to as a transmission and reception point (TRP). For example, when the wireless communications system 1 is a LTE system, the BS may be an evolved NodeB (eNB).

The BS 20 includes antennas, a communication interface to communicate with an adjacent BS 20 (for example, X2 interface), a communication interface to communicate with the core network 30 (for example, S1 interface), and a CPU (Central Processing Unit) such as a processor or a circuit to process transmitted and received signals with the UE 10. Operations of the BS 20 may be implemented by the processor processing or executing data and programs stored in a memory. However, the BS 20 is not limited to the hardware configuration set forth above and may be realized by other appropriate hardware configurations as understood by those of ordinary skill in the art. Numerous gNBs 20 may be disposed so as to cover a broader service area of the wireless communication system 1.

The UE 10 may communicate DL and UL signals that include control information and user data with the BS 20 using MIMO technology. The UE 10 may be any type of users, a mobile (user) terminal, a mobile station, a smartphone, a cellular phone, a tablet, a mobile router, or information processing apparatus having a radio communication function such as a wearable device. The wireless communication system 1 may include one or more UEs 10.

The UE 10 includes a CPU such as a processor, a RAM (Random Access Memory), a flash memory, and a radio communication device to transmit/receive radio signals to/from the BS 20 and the UE 10. For example, operations of the UE 10 described below may be implemented by the CPU processing or executing data and programs stored in a memory. However, the UE 10 is not limited to the hardware configuration set forth above and may be configured with, e.g., a circuit to achieve the processing described below.

Embodiments of the present invention include protocols and procedures for downlink CSI-RS or pilot configuration for a massive MIMO system (e.g., NR system) with multiple beam cells at the BS 20 (e.g., RRH or gNB), in conjunction with methods and apparatuses for beam cell generation at the BS as well as the beam cell selection and/or channel estimation of the selected beam cell at UEs based on the DL CSI-RS detection. Embodiments of the present invention can enable large densification benefits to be realized in the DL transmission as well as DL reception of wireless networks.

A class of methods and apparatuses are disclosed, which allow increasing the network spectral efficiency of CSI-RS transmission. Methods rely on the combined use of appropriately designed CSI-RS beam pattern for virtual beam cells, and mechanisms for fast beam detection at each user equipment. The designed CSI-RS beam pattern can be used for virtual beam cell selection as well as downlink CSI estimation of identified virtual beam cell.

Although the disclosed mechanisms are described in the context of the macro-assisted RRH system, it can be readily applied in other related scenarios. By way of example, these concepts may be extended to Evolution-Data Optimized (EV-DO) or Ultra Mobile Broadband (UMB). EV-DO and UMB are air interface standards promulgated by the 3rd Generation Partnership Project 2 (3GPP2) as part of the CDMA2000 family of standards and employs CDMA to provide broadband Internet access to mobile stations. These concepts may also be extended to Universal Terrestrial Radio Access (UTRA) employing Wideband-CDMA (W-CDMA) and other variants of CDMA, such as TD-SCDMA; Global System for Mobile Communications (GSM) employing TDMA; and Evolved UTRA (E-UTRA), IEEE 802.11 (Wi-Fi), IEEE 802.16 (WiMAX), IEEE 802.20, and Flash-OFDM employing OFDMA. UTRA, E-UTRA, UMTS, LTE and GSM are described in documents from the 3GPP organization. CDMA2000 and UMB are described in documents from the 3GPP2 organization. The actual wireless communication standard and the multiple access technology employed will depend on the specific application and the overall design constraints imposed on the system.

One such embodiment, considers synchronized small cells, low power nodes (LPNs), BSs, RRHs, co-located sectors with directional antennas per RRH site, virtual cells or sectors with different spatial filters per RRH site using large antenna arrays, femto cells or distributed antennas.

(System Model)

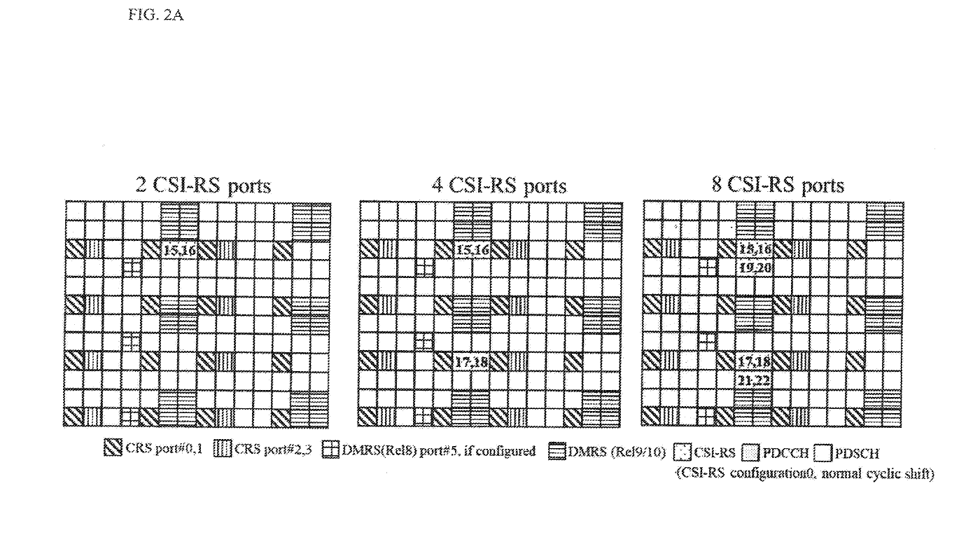

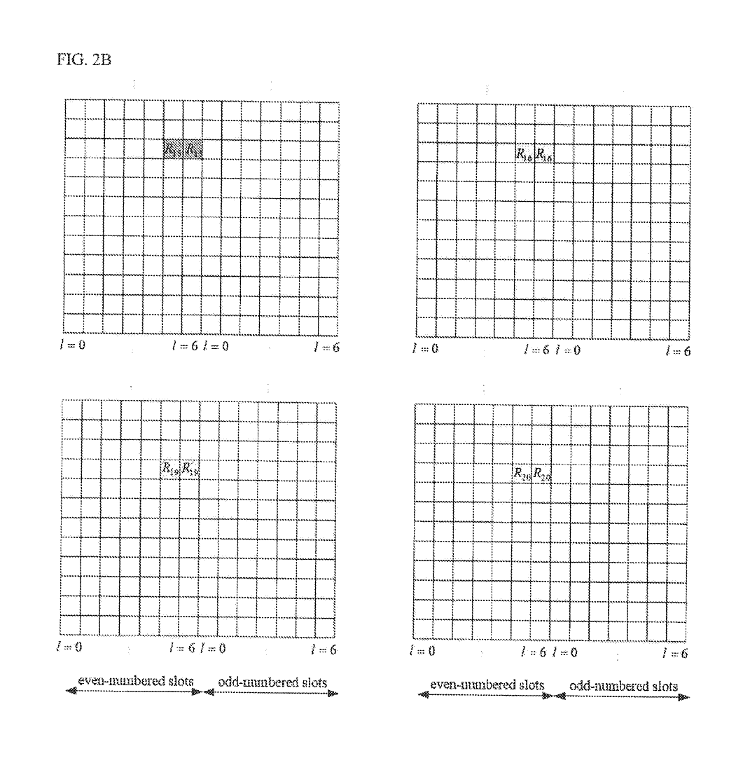

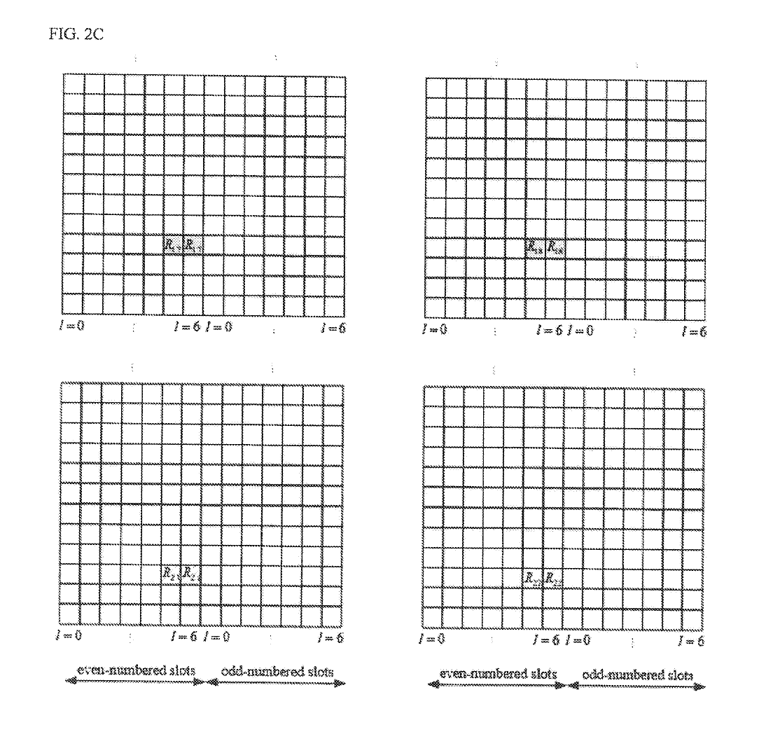

Methods disclosed herein are henceforth described in detail for the wireless communication system 1. Similar methods can be straightforwardly applied to networks of small-cells, access points, etc. Without loss of generality, the following scenario involving a center processor (CP) at a macro cell is described, which controls the BS 20 (J RRH sites) serving multiple active UEs 10, as shown in FIG. 2, that is serving a UE 10 population based on orthogonal frequency-domain multiplexing access (OFDMA), including multi-carrier FDMA, single-carrier FDMA.

The time/spectrum resources are split into resource blocks (RBs), which a block of contiguous subcarriers and symbols. It is assumed that within each RB, a subset of UEs 10 across the network are active, i.e., are scheduled for transmission. Without loss of generality, it is assumed that a scheduler operation occurs, according to which the set of active UEs 10 is the same across several concurrent time slots or OFDM symbols. Although not necessary, to make the treatment concrete, a block-fading channel model is assumed where the channel coefficients remain constant within each RB/slot.

In one or more embodiments of the present invention, it is assumed that the mmWave bands are used for high-rate data transmission since it offers the promise of orders of magnitude available bandwidth additional to the current LTE-based cellular networks. The much larger number of antennas at the BS 20 that can be supported in a small footprint at mmWave bands. Even with one or two antennas at the UE 10, the BS 20 with massive MIMO is able to create very sharp beams to the UE 10 in proximity, so as to shed more signal power on the desired UE 10 and less interference on undesired UEs 10.

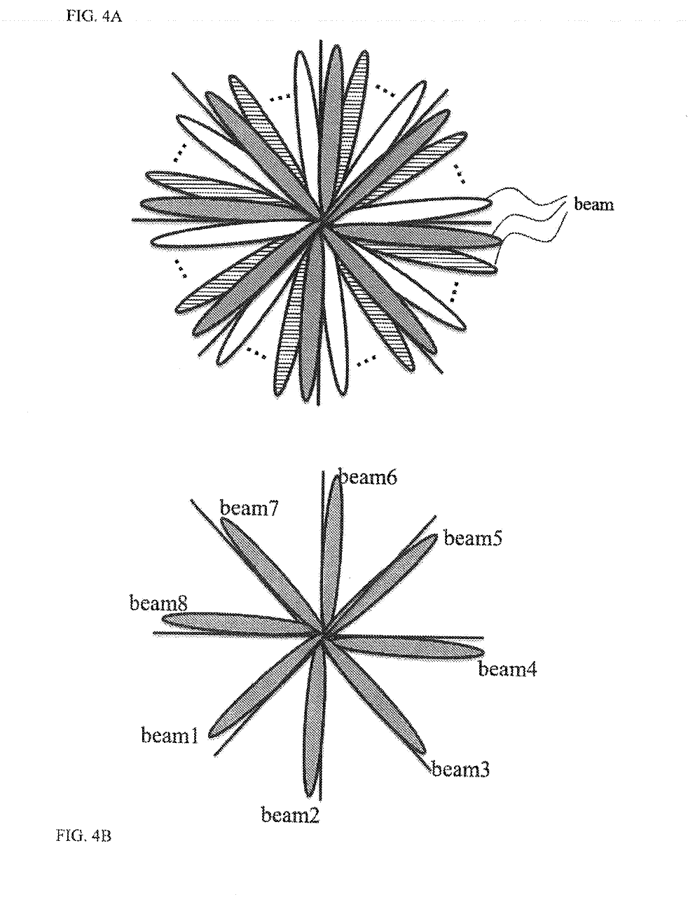

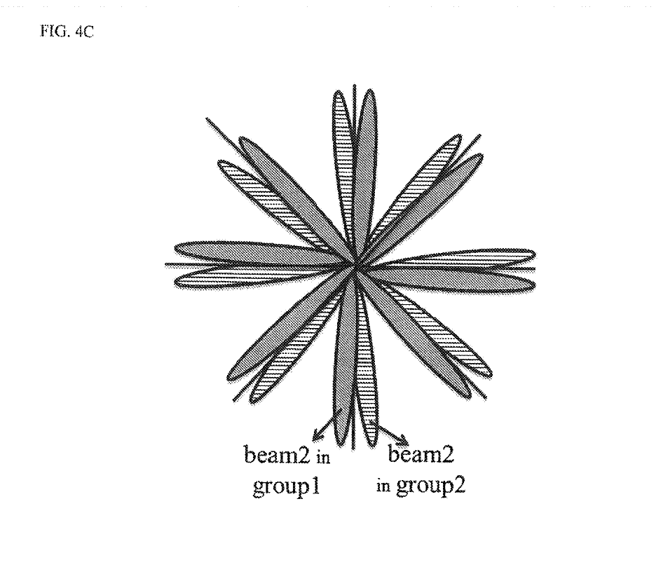

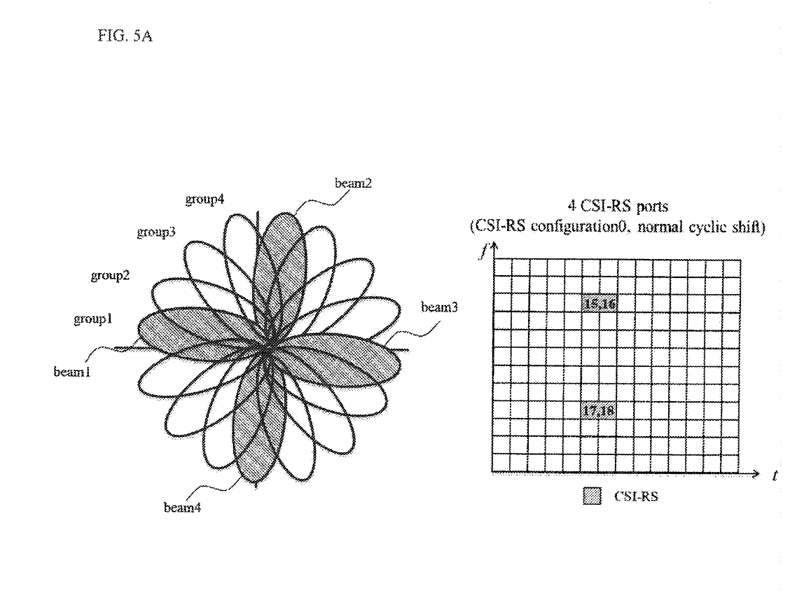

It is assumed the BS 20 uses Massive MIMO beamforming to boost the limited transmit power at the beam direction so as to increase the downlink coverage. As illustrated in the FIGS. 4A and 4B, the transmitter generates a large number of virtual beam cells. It is regarded as virtual cells or sectors since all these beam cells are sharing the same cell ID and their beam configuration, such as beam direction, beam shape, beam precoding vector, may not need to be informed to the UEs 10. On the contrary, the UE 10 will detect and select which beam direction among the virtual beam cells is the best one(s) with strongest received power so as to achieve the highest data rate.

The virtual beam cell configuration is controlled by network and there are orthogonal and quasi-orthogonal or non-orthogonal beams to achieve seamless coverage. The virtual beam cells are divided into different groups. The beams within one group are orthogonal to each other (i.e., at least their beam main-lobes are non-overlapped and the interference between their beam side-lobes are relatively low, which may be ignored); while the quasi/non-orthogonal beams should be put in different groups (i.e., part of their beam main lobes may be overlapped and/or the interference between the beam side-lobes are relatively high, which may not be ignored). The beams in one group are allocated common resources, e.g., same CSI-RS antenna port and CSI-RS configurations of RE position; but the beams in different group are using orthogonal resources, e.g., different CSI-RS antenna ports and different CSI-RS configurations of RE position.

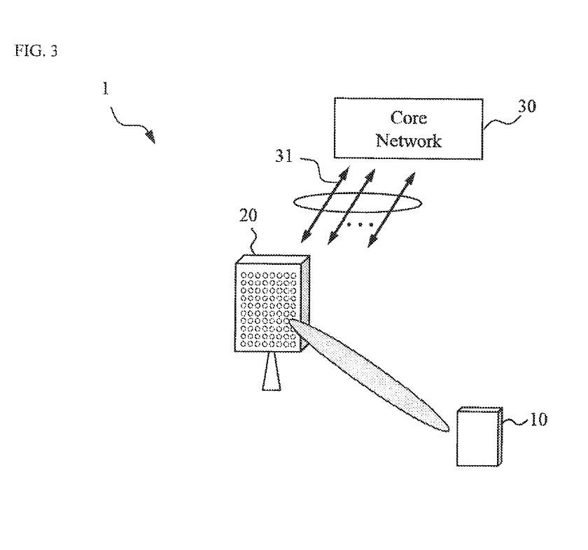

As illustrated in FIG. 4A, there are 64 narrow beams, which are generated by Massive MIMO and co-located at the same BS 20. Every 8 orthogonal beams, {beam 1, 2, . . . 8} illustrated in FIG. 4B, with spaced in spatial domain are grouped together. Thereafter, there are 8 groups in total. As shown in FIG. 3C, the beam 1 in Group1 and beam 1 in Group2 are quasi/non-orthogonal to each other.

To avoid the inter-beam interference, the BS 20 send the CSI-RSs for the beams in different groups on orthogonal resources, such as orthogonal antenna ports, different time slots, subcarriers or resource blocks. The configuration information of CSI-RSs for each group is indicated to the UEs 10, which can be regarded as group-specific information. The orthogonal beams within one group do not interfere with each other. The orthogonal beams are allocated common resources, such as same CSI-RS antenna port, same time slot, same subcarrier, or any combination. In order to let the UEs 10 identify the CSI-RSs sent on the common for respective orthogonal beam within the same group, the CSI-RS beam patterns are introduced, which can implicitly separate the CSI-RSs on the common resources with no more additional signal information. Therefore, 64 CSI-RSs for 64 beams in FIG. 3A only cost 8 groups or 8 sets of orthogonal resources instead of 64 orthogonal resources. In addition, the network only informs the group-specific configuration information of 8 CSI-RS groups. The UEs 10 detect the CSI-RS pattern to identify the corresponding beam within the group.

Therefore, the CSI-RS pattern is identified by the parameter set of {group index, beam index}. Different beam groups may be allocated to respective antenna port so that the group index is the same as the corresponding port index. Conventionally, the network sets the number of CSI-RS antenna ports equal to the total number of antennas. The group number is set as the antenna port number and the maximum number of beams, equal to the group number multiplexed with beam number per group, is smaller or equal to the total number of transmit antennas.

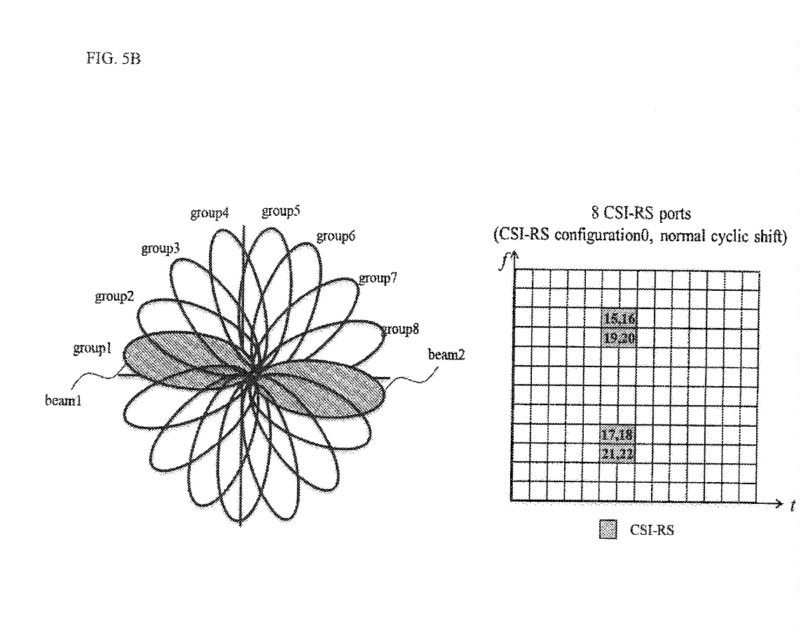

Assuming there are 16 beams generated at the BS 20, the network may configure the CSI-RS patterns as FIG. 5A with group 1-4 and beam 1-4 per group and map the 4 groups on 4 CSI-RS ports. Another option is to configure the CSI-RS patterns as FIG. 5B with group 1-8 and beam 1-2 per group and map the 8 groups on 8 CSI-RS ports. Compared with CSI-RS patterns in FIG. 5B, the CSI-RS patterns in FIG. 5A cost less overhead and more remaining REs per RB for data transmission. Also, there are more CSI-RS configurations of RE position within each RB, which enables easier network planning and decreases the CSI-RS to CSI-RS collisions. On the other hand, more beams per group cost less number of CSI-RS ports, but it may suffer from larger inter-beam interference at the side lobes of the beams within the group.

For multiple DL precoded CSI-RS of a group of orthogonal beams multiplexed on the same resources, the CSI-RS patterns are configured to implicitly identify different beams. For illustration, Pattern 1 indicates a beam-specific power configuration for CSI-RS resource units (explained in one or more embodiments of a first example of the present invention) and Pattern 2 indicates a beam-specific scrambling sequence for CSI-RS sequences (explained in one or more embodiments of a second example of the present invention).

Besides CSI-RS, other downlink reference signals may also use the beamforming with massive MIMO to extend their coverage, such as synchronization signals (SS) including primary SS (PSS) and secondary SS (SSS), cell-specific RS (CRS), positioning reference signals (PRS), MBSFN signals, as well as discovery signals. The various types of beam-specific RSs are useful for beam synchronization/detection, beam selection and/or beam-specific channel estimation. The beam-specific pattern, applied on the precoded reference signals, is flexible to use any pattern as illustrated or even their combinations.

In one or more embodiments of the present invention, an example will be described that the wireless communication system is a massive MIMO system on the mmWave bands, but the present invention is not limited thereto. In one or more embodiments of the present invention, a MIMO system operating on the lower or higher carrier frequency may be the wireless communication system. Also, the present invention is not limited to a system with each node equipped with massive MIMO. One or more embodiments of the present invention may be extended to a system of spatially separated antenna nodes connected to a common source via a transport medium/backhaul that provides wireless service within a geographic area or structure.

The described examples and modified examples may be combined with each other, and various features of these examples can be combined with each other in various combinations. The present invention is not limited to the specific combinations disclosed herein.

Although the disclosure has been described with respect to only a limited number of embodiments of the present invention, those skilled in the art, having benefit of this disclosure, will appreciate that various other embodiments may be devised without departing from the scope of the present invention. Accordingly, the scope of the invention should be limited only by the attached claims.

### First Example

(Beam-Specific CSI-RS Pattern Configuration)

According to one or more embodiments of a first example of the present invention, the BS 20 may generate a CSI-RS that is quasi-orthogonally or non-orthogonally multiplexed on multiple resource elements (REs) and transmit the CSI-RS to the UE 10. For example, different transmission power may be applied to the multiple REs on which the CSI-RS is multiplexed. For example, the BS 20 may notify the UE 10 of transmission power information that indicates values (level) of the applied different transmission power.

In one or more embodiments of the present invention, the resource element (RE) is referered to as a resource unit (RU) or a resource. For example, the REs mapped to the CSI-RS may be indicated as a CSI-RS REs or a CSI-RS RUs.

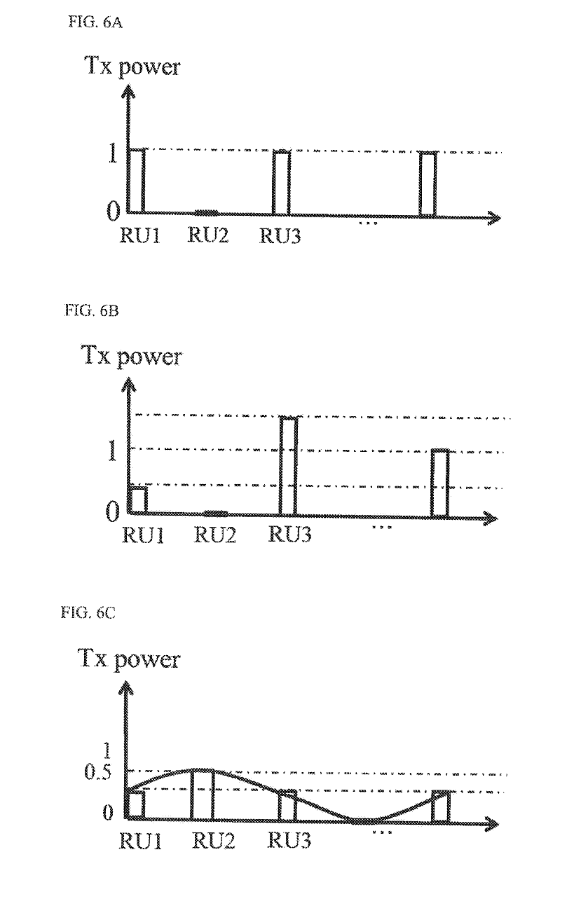

One or more embodiments of a first example of the present invention introduce the beam-specific CSI-RS pattern with different power level setting on the CSI-RS RUs as shown in FIGS. 6A-6C. One example is to set 0/1 binary-power level as in FIG. 6A and another example is to set 0/0.5/1/1.5 four-power level as in FIG. 6B. It is possible to set the contiguous power level, such as the sine function as shown in FIG. 6C. However, more power level choices may include more information but require more complicated receiver processing and less robust against the noise and interference. The resource units (RUs) could be a RB with CSI-RS transmitted or one or more resource elements on the CSI-RS antenna port set S, where S={15} if CDMType is not configured, or S={15,16}, S={17,18}, S={19,20}, S={21,22} in case of CDMType=CDM2, or S={15,16,17,18}, S={19,20,21,22}, S={23,24,25,26} for CSI reference signals on 12 ports in case of CDMType=CDM4, or S={15,16,19,20}, S={17,18,21,22}, S={23,24,27,28} or S={25,26,29,30} for CSI reference signals on 16 ports in case of CDMType=CDM4. Here, a zero-power resource can be configured as a part of NZP RS resource or ZP RS resource (including interference measurement resource (IMR)).

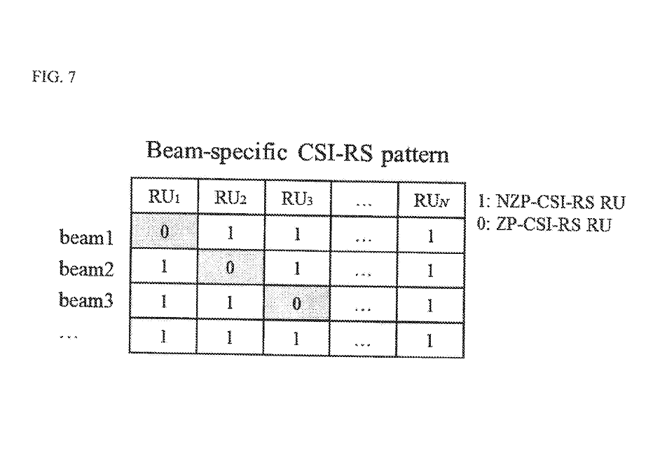

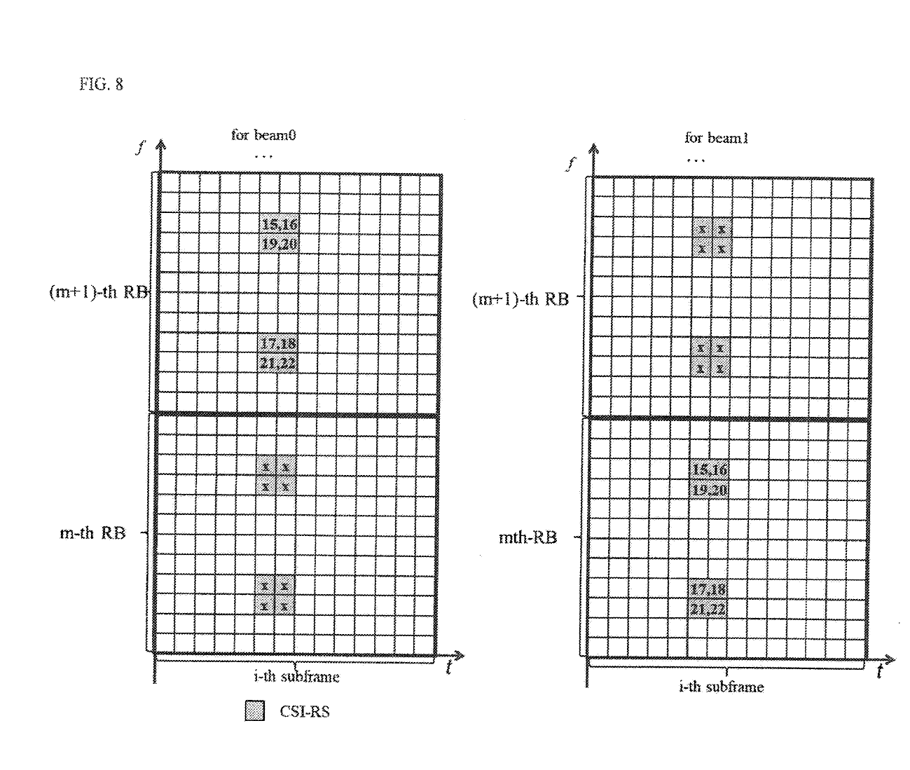

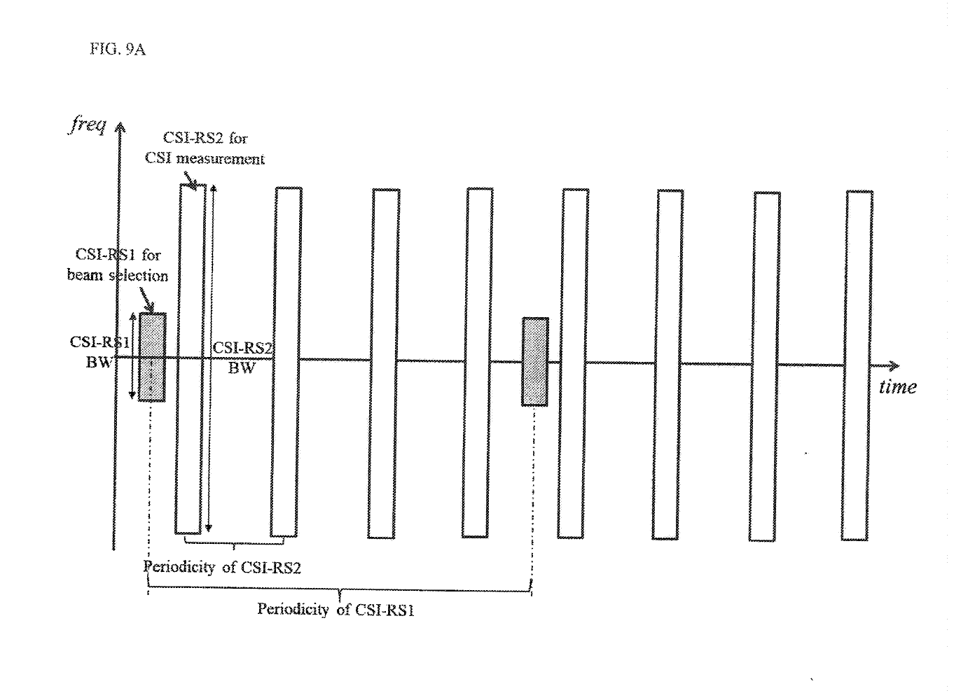

The beam-specific CSI-RS patterns for a group of orthogonal beams based on 0/1 binary power level setting is illustrated in FIG. 7. Each CSI-RS pattern corresponding to one of the beams are allocated on common CSI-RS resources with number of N RUs and CSI-RS pattern consists of the quasi/non-orthogonal 0/1 codes. The ‘0’ element represents the zero-power (ZP) CSI-RS RU and the ‘1’ element is the non-zero-power (NZP) CSI-RS RU. Among N CSI-RS RUs, there are the ‘l’ number of ZP-CSI-RS RUs with l>=1. At least one of the ZP-CSI-RS RU for each beam is non-overlapped. The remaining ‘N-l’ number of NZP-CSI-RS RUs are used to estimate the CSI at the receiver side. The CSI-RS pattern illustrated in FIG. 7 has l=1 ZP-CSI-RS RU, where each beam has a unique ZP-CSI-RS RU as the beam index. The quasi/non-orthogonal CSI-RS patterns can multiplex up to ‘N’ number of orthogonal beams.

The CSI-RS sequences may be generated by different ways. One way is to generate a pseudo-random sequence with the length of ‘N’ elements. The ‘l’ number of ZP-CSI-RS elements will be punctured for each beam-specific CSI-RS pattern. The correlation characteristics may be compromised slightly by controlling N>>l. Another way is to directly generate a pseudo-random sequence with the length of ‘N-l’ elements and map each element on the NZP-CSI-RS element position according to the beam-specific CSI-RS pattern. In this case, the receiver side may detect the position of ZP-CSI-RS RU(s) first before using detecting the PN sequence. Other sequences with good auto-/cross-correlation characteristics may also be used, such as Barker sequence, Gold sequence, etc.

One or more embodiments of the present invention may be to use the same antenna port as well as same CSI-RS configuration for NZP-CSI-RS RUs and ZP-CSI-RS RUs for a group of orthogonal beams but puncture the power of the ZP-CSI-RS RUs. As illustrated in FIG. 8, there are 8 CSI-RS ports and the CSI-RS configuration 0 on each CSI-RS port is used for all the RBs with CSI-RS. With same CSI-RS configuration 0, the NZP-CSI-RS RU and ZP-CSI-RS RU positions in each RB are same for each port, but only the transmit power on the ZP-CSI-RS RUs is set ‘0’ but the power of NZP-CSI-RS RUs are set ‘1’. The CSI-RS port indexes 15-22 are marked in the NZP-CSI-RS RUs; while the ZP-CSI-RS RUs are the RUs with the mark ‘x’. The ZP-CSI-RS RUs are beam-specific. As illustrated in FIG. 8, the beams on the same port are using same resources but the m-th RB is configured to have the ZP-CSI-RS RUs of beam 1 but the (m+1)-th RB is for that of beam 2. Because the same CSI-RS configuration is used for the antenna ports in the set S, the configuration of ZP-CSI-RS RUs for the beams mapping on the antenna port set should be same. In FIG. 8, CDMType=CDM2 and S={15,16}, S={17,18}, S={19,20}, S={21,22}. At least, the REs in the same antenna port set S should be configured together and the REs in the same ZP-CSI-RS RU for the beams on each antenna port set S. In FIG. 8, the m-RB for the ZP-CSI-RS RUs of beam 0 on all the CSI-RS port 1-8 and the (m+1)-RB for the ZP-CSI-RS RUs of beam 1 on all the CSI-RS port 1-8 is chosen. Thus, the multiple CSI-RSs may be quasi-orthogonally or non-orthogonally multiplexed on the REs mapped to the multiple CSI-RSs.

The periodic CSI-RS has already been supported in LTE Release 10, where the BS 20 will inform the RRC signaling related to the CSI-RS parameters to the RRC-connected UEs 10, illustrated as:
CSI-RS state: On/off
CSI-RS sequence generation based on cell ID
CSI-RS total bandwidth in terms of number of RBs
CSI-RS power: −60.00-200.00 dB
Number of CSI-RS antenna ports: 1/2/4/8/12/16
CSI-RS Antenna Port: port 15/port15-16/port15-18/port15-22/port15-26/port15-30
CSI-RS Configuration including Table 6.10.5.2-1 in TS36.211 for normal cyclic prefix and Table 6.10.5.2-2 in TS36.211 for extended cyclic prefix
CSI-RS Subframe Configuration (I_CSI-RS): 0-154
   The CSI-RS Subframe Configuration index which defines both the CSI-RS Periodicity (T_CSI-RS) and the CSI-RS Subframe Offset parameters (Delta_CSI-RS). Subframes containing CSI reference signals shall satisfy: (10SFN+Floor(Slot#/2)-Delta_CSI-RS)mod T_CSI-RS=0 with
      I_CSI-RS=0 to 4, T_CSI-RS=5, Delta_CSI-RS=I_CSI-RS
      I_CSI-RS=5 to 14, T_CSI-RS=10, Delta_CSI-RS=I_CSI-RS-5
      I_CSI-RS=15 to 34, T_CSI-RS=20, Delta_CSI-RS=I_CSI-RS-15
      I_CSI-RS=35 to 74, T_CSI-RS=40, Delta_CSI-RS=I_CSI-RS-35
      I_CSI-RS=75 to 154, T_CSI-RS=80, Delta_CSI-RS=I_CSI-RS-75

By adapting the proposed beam-specific CSI-RS patterns, the higher-layer (RRC) CSI-RS parameters should include the parameters for NZP-CSI-RS RUs as well as those for ZP-CSI-RS RUs. This beam-specific CSI-RS can be used for DL beam detection/selection and/or DL beam CSI estimation. Especially, the parameters for ZP-CSI-RS configuration are required to let UEs 10 carry out beam detection/selection based on energy detection by identifying the NZP-CSI-RS REs/ZP-CSI-RS REs of the strongest virtual beam cell.

The CSI-RS parameters for beam detection/selection may be only used for RRM measurement of large-scale fading and beam gain instead of small-scale fading. In order to let UEs 10 select the best beam(s) based on simultaneous transmission of a larger number of beam-specific CSI-RS, the eNB/BS 20 may focus the limited CSI-RS transmit power on a narrow subband as the configured CSI-RS bandwidth and distribute the transmit power on the simultaneously-transmitted CSI-RSs. But the CSI-RS bandwidth should include at least ‘N’ umber of RBs to separate N orthogonal beams per group, assuming that only ‘1=1’ ZP-CSI-RS RU per RB per beam is used in the beam-specific CSI-RS pattern. For example, at least 8 RBs are required to configure 8 respective ZP-CSI-RS RUs for 8 beams per group. The coverage of CSI-RS is not changed by focusing the power to transmit 8 beam-specific CSI-RSs simultaneously on only 8 RBs instead of only one CSI-RS on 64RBs.

Therefore, for beam detection/selection, the higher-layer NZP-CSI-RS parameters and ZP-CSI-RS parameters are required, illustrated as:

Common parameters:
CSI-RS total bandwidth in terms of Total number of CSI-RS RBs
CSI-RS power: −60.00-200.00 dB
Number of CSI-RS antenna ports: 1/2/4/8/12/16
CSI-RS Antenna Port: port 15/port15-16/port15-18/port15-22/port15-26/port15-30
CSI-RS Configuration including Table 6.10.5.2-1 in TS36.211 for normal cyclic prefix Table 6.10.5.2-2 in TS36.211 for extended cyclic prefix
   NZP-CSI-RS parameters:
NZP-CSI-RS state: On/off
NZP-CSI-RS sequence generation based on cell ID
NZP-CSI-RS Subframe Configuration (I_CSI-RS): 0-154
   The NZP-CSI-RS Subframe Configuration index which defines both the NZP-CSI-RS Periodicity (T_NZP-CSI-RS) and the NZP-CSI-RS Subframe Offset parameters (Delta_NZP-CSI-RS). Subframes containing CSI reference signals shall satisfy: (10SFN+Floor(Slot#/2)-Delta_NZP-CSI-RS)mod T_NZP-CSI-RS=0 with
      I_NZP-CSI-RS=0 to 4, T_NZP-CSI-RS=5, Delta_NZP-CSI-RS=I_NZP-CSI-RS
      I_NZP-CSI-RS=5 to 14, T_NZP-CSI-RS=10, Delta_NZP-CSI-RS=I_NZP-CSI-RS-5
      I_NZP-CSI-RS=15 to 34, T_NZP-CSI-RS=20, Delta_NZP-CSI-RS=I_NZP-CSI-RS-15
      I_{—} NZP-CSI-RS=35 to 74, T_NZP-CSI-RS=40, Delta_NZP-CSI-RS=I_NZP-CSI-RS-35
      I_{—} NZP-CSI-RS=75 to 154, T_NZP-CSI-RS=80, Delta_NZP-CSI-RS=I_NZP-CSI-RS-75
         ZP-CSI-RS parameters:
ZP-CSI-RS State: On/off
   If ZP-CSI-RS State=Off, no detection of ZP-CSI-RS
ZP-CSI-RS Subframe Configuration (I_ZP-CSI-RS): 0-154
   The CSI-RS Subframe Configuration index which defines both the ZP-CSI-RS Periodicity (T_ZP-CSI-RS) and the ZP-CSI-RS Subframe Offset (Delta_ZP-CSI-RS). Subframes containing ZP-CSI-RS shall satisfy: (10SFN+Floor(Slot#/2)-Delta_ZP-CSI-RS)mod T_ZP-CSI-RS=0
      I_ZP-CSI-RS=0 to 4, T_ZP-CSI-RS=5, Delta_ZP-CSI-RS=I_ZP-CSI-RS
      I_ZP-CSI-RS=5 to 14, T_ZP-CSI-RS=5, Delta_ZP-CSI-RS=I_ZP-CSI-RS-5
      I_ZP-CSI-RS=15 to 34, T_ZP-CSI-RS=20, Delta_ZP-CSI-RS=I_ZP-CSI-RS-15
      I_ZP-CSI-RS=35 to 74, T_ZP-CSI-RS=40, Delta_ZP-CSI-RS=I_ZP-CSI-RS-35
      I_ZP-CSI-RS=75 to 154, T_ZP-CSI-RS=80, Delta_ZP-CSI-RS=I_ZP-CSI-RS-75
   Default: same as CSI-RS Subframe Configuration (I_CSI-RS)
ZP-CSI-RS RB allocation mode: 0/1
   0: contiguous RB allocation
   1: distributed RB allocation
Number of beams on each CSI-RS port (N_Beam_Per_Port): 0, 1, . . . .
Number of RUs for the ZP-CSI-RS per beam per port (N_RU_ZP-CSI-RS_Per_Beam_Per_Port): 0, 1, 2, . . . .
   0 if ZP-CSI-RS State=Off
ZP-CSI-RS subband configuration (Subband_ZP-CSI-RS): narrow down the searching range of ZP-CSI-RS to simply the blind detection
   RB offset of ZP-CSI-RS (Delta_RB_ZP-CSI-RS)
   RB number of ZP-CSI-RS (Number_RB_ZP-CSI-RS)
Threshold for NZP/ZP-CSI-RS (Thr) (if network-controlled)
Threshold to trigger aperiodic beam-specific CSI-RS transmission (Trigger_Thr) (if network-controlled)

Typically, NZP-CSI-RS and ZP-CSI-RS may share the common parameters for resource element configuration per RB, such as (Total number of CSI-RS RBs), (Number of CSI-RS antenna ports), (CSI-RS Antenna Port) and (CSI-RS Configuration), and each UE 10 can find out the subcarrier and symbol index of NZP-CSI-RS REs or ZP-CSI-RS REs in each RB according to the Table 6.10.5.2-1 in TS36.211 for normal cyclic prefix or Table 6.10.5.2-2 in TS36.211 for extended cyclic prefix. But the exact subcarrier RB position of the beam-specific ZP-CSI-RS may not be indicated and each UE 10 relies on the blind energy detection to select the proximate virtual beam cell(s).

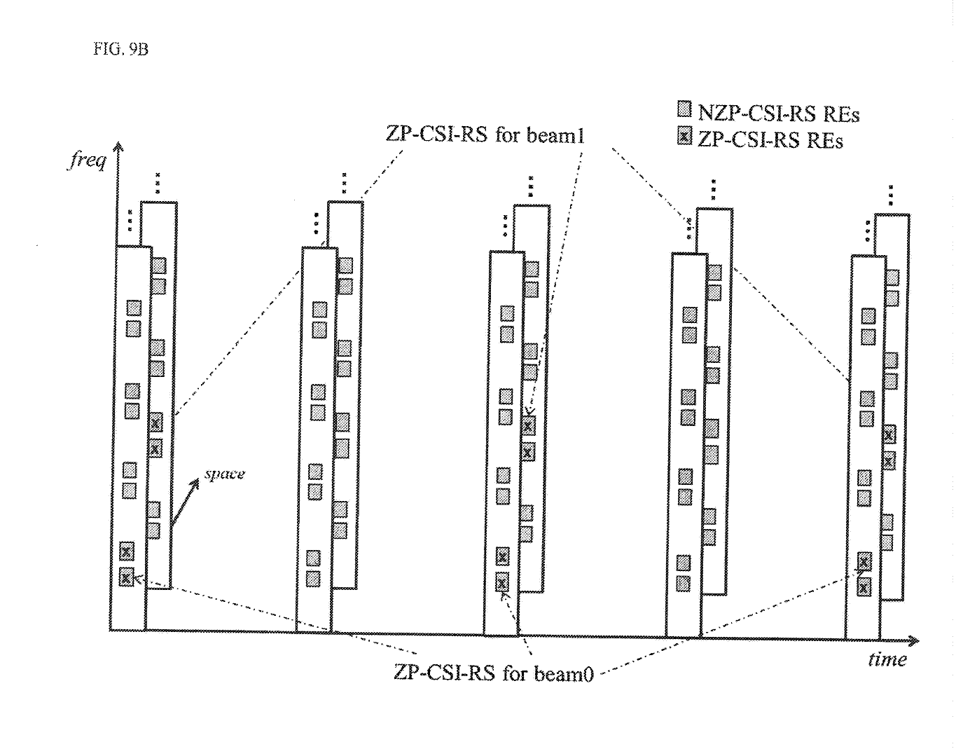

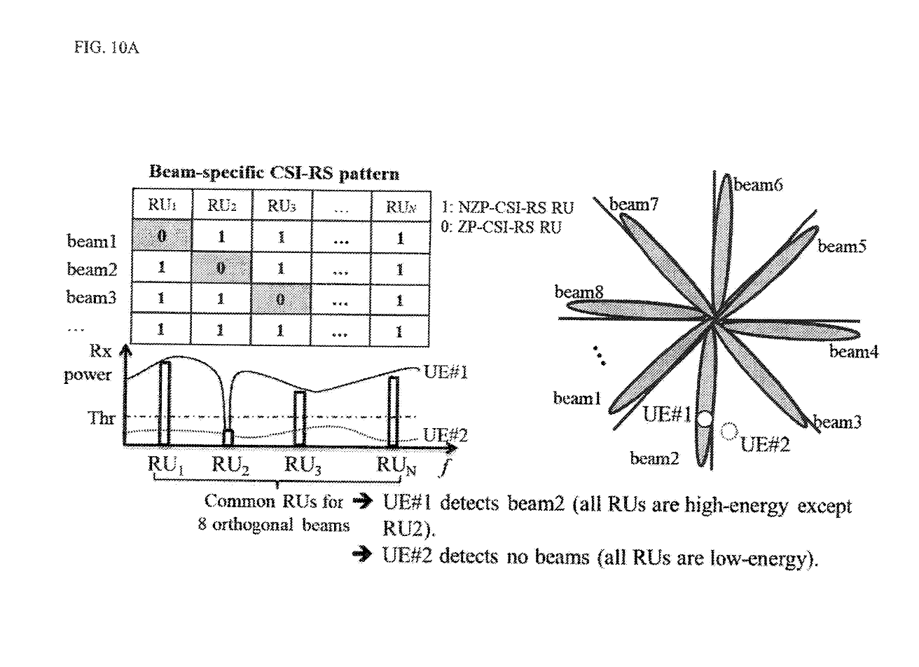

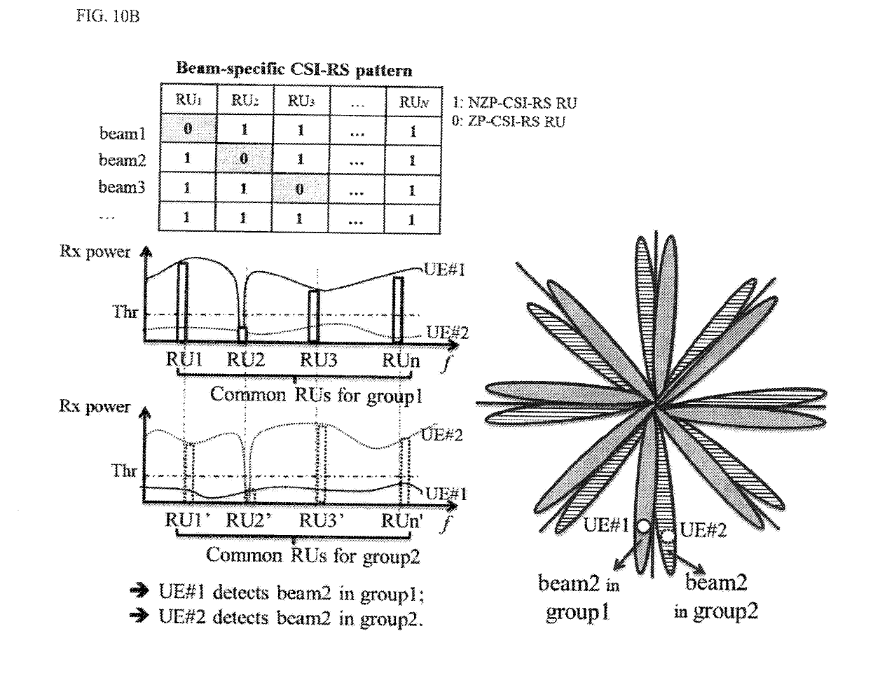

It is flexible to configure the bandwidth, periodicity and subframe offset of the CSI-RS according to different requirements. As illustrated in FIG. 9A, the network configure two types of CSI-RSs, where CSI-RS1 is configured for beam selection and the power on narrow bandwidth of CSI-RS1 can support a large number of beam-specific CSI-RSs. CSI-RS2 is configured for CSI measurement with wide bandwidth and the power is used to send only the selected-beam CSI-RS(s). Also, in CSI-RS2, no ZP-CSI-RS is needed, i.e., ZP-CSI-RS of CSI-RS2 is switched off. The beam selection based on CSI-RS1 could be less frequently carried out than the CSI estimation based on CSI-RS2. The NZP-CSI-RS Subframe offset (Delta-NZP-CSI-RS) of CSI-RS1 and CSI-RS2 is also different.

It is also possible to carry out the beam selection and CSI measurement at the same time. The network may configure one CSI-RS but set different periodicity for NZP-CSI-RS and ZP-CSI-RS, but keep same Delta-ZP-CSI-RS as Delta-NZP-CSI-RS. As illustrated in FIG. 9B, T_ZP-CSI-RS=2*T_NZP-CSI-RS but the ZP-CSI-RS REs are transmitted with the same subframe offset as that of NZP-CSI-RS REs. The NZP-CSI-RS REs for beam 0 and beam 1 are overlapped but their ZP-CSI-RS REs are different.

Also, some high-layer ZP-CSI-RS parameters for the measurement based on beam-specific CSI-RS patterns are useful to reduce the blind detection complexity of the CSI-RS pattern detection, which will be described below. Also, some high-layer ZP-CSI-RS parameters for beam switch based on beam-specific CSI-RS patterns, such as (Trigger_Thr), will be described below.

Besides the periodic CSI-RS transmission, it is also useful to configure aperiodic CSI-RS transmission to reselect the virtual beam cell(s) and/or aperiodic CSI feedback/reporting, especially in case that a mobile UE 10 is moving from one narrow beam cell to another narrow beam cell. The aperiodic CSI-RS transmission may be triggered by a UE 10, when the UE 10 finds out the received power on the NZP-CSI-RS RUs of the current beam cell is weaker than a threshold (details in Sect. 5.2.4). The UE 10#1 may send a request to ask BS 20 send the aperiodic CSI-RS. The network may configure to send the CSI-RS of several beam cells, which are close to the current beam cells, as candidate target beam cells.

Regarding transmit power of CSI-RS RUs, there are several options. Assuming the total CSI-RS transmit power Ptx for all the beams on every port, the CSI-RS transmit power per port is calculated as Ptx_Per_port=Ptx/(Number of CSI-RS antenna ports). Since there are (N_Beam_Per_Port) number of beams per port transmitted simultaneously, the CSI-RS transmit power per beam is equal to Ptx_Per_port_Per_Beam=Ptx_Per_port/(N_Beam_Per_Port). One way is to keep the same power spectrum density and the transmit power for each NZP-CSI-RS RU is equal to Ptx_Per_port_Per_Beam/N for all the ‘N’ number of CSI-RS RUs. It is simple to puncture the power on the ‘l’ number of ZP-CSI-RS RUs. However, the total transmit power for CSI-RS is reduced as βPₜₓ with β=1−l/N. One way is to keep the same total transmit power of CSI-RS RUs per beam as Ptx_Per_port_Per_Beam, which is distributed only on the NZP-CSI-RS RUs as Ptx_Per_port_Per_Beam/(N−l). The channel estimation is slightly improved by focusing the power on ‘N−l’ NZP-CSI-RS RUs.

(Beam-Specific CSI-RS Pattern Detection)

By using the defined CSI-RS patterns on the configured set of CSI-RS RUs, the UE 10 can locally carry out the energy detection to identify whether it is in the coverage of any beam with strong received power. If it detects the strong beam, the UE 10 can further identify the beam index according to the corresponding ZP-CSI-RS RU index.

The energy detection is to compare the receive power level on the configured CSI-RS RUs with a threshold. Let yᵢ[n]=[y_{i,1}[n], y_{i,2}[n], . . . , y_{i,Mi}[n]]^{T} denote the received signal on the n-th CSI-RS RU by the Mᵢ antenna array at i-th UE 10. Let Λ[n]=(|y_{i,1}[n]|²+|y_{i,2}[n]|²+ . . . +|y_{i,Mi}[n]|²)/Mᵢ denote the average received signal energy across the received antennas on the n-th CSI-RS RU. The narrow beam based on the use of transmitter Massive MIMO significantly increase the power level of the strongest path and equivalently reduce the channel delay spread, resulting less sever fading in the frequency domain. At the j-th receive antenna, |y_{i,j}[n]|² is already flat for any CSI-RS RU in the frequency domains. For large Mᵢ at the receiver side, the channel hardening phenomenon further averages out the fast fading. Therefore, Λ[n] is approximately to the same value, only dependent on the large-scale fading but not sensitive to the fast fading on each subcarrier. As a result, if Λ[n] is lower than the Threshold of user-proximity detection, the n-th RU is regarded as a ZP-CSI-RS RE. Otherwise, if Λ[n] is higher than the Threshold, the n-th RU is regarded as a NZP-CSI-RS RE. According to the hard-decision results, if all the subcarriers have low energy, the i-th UE 10 is not in any of the beams on the sets of CSI-RS REs. If the low-energy RUs are exactly the l ZP-CSI-RS RU indexes of the k-th CSI-RS pattern for the k-th beam, the k-th beam cell is selected by the i-th UE 10. Although the orthogonal beams sent on the same set of CSI-RS RUs can significantly reduce the main-lobe beam contamination seen at the user receiver side, the side-lobe beam contamination may result in less than l number of the low-energy RUs. In such case, the UE 10 cannot identify the CSI-RS pattern and no beam is selected since the received energy is not enough to get accurate channel estimation against interference plus noise.

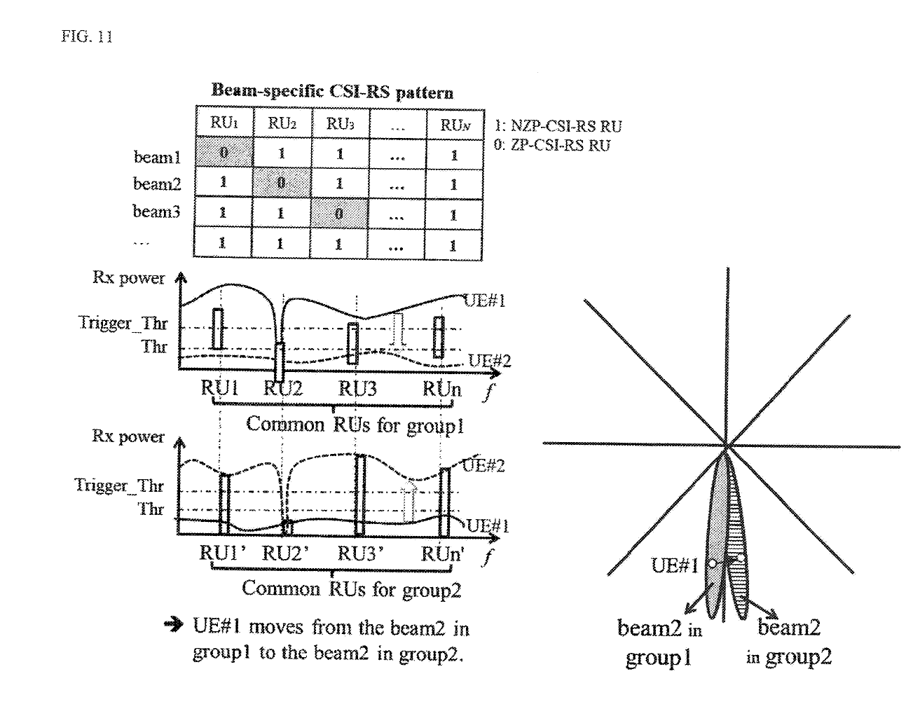

An example is shown in FIG. 10A, where UE 10#1 is within the coverage of beam 2 in group 1. The UE 10#1 finds out the low-energy at the RE2 and the high-energy at other REs, which is same as the CSI-RS pattern of beam 2. Accordingly, the UE 10#1 selects the beam 2. However, the UE 10#2 is out of the coverage of all the beams in group 1. The received power of all the RUs at the UE 10#2 is low-energy so that no beam in group1 is selected. In FIG. 10B, the UE 10#2 is in the beam 2 of group2, but UE 10#1 is not. In the same way, the UE 10#2 finds out the unique low-energy RE2 and the beam 2 in group2 is selected according to the beam 2 CSI-RS pattern configuration. But no beam in group2 is selected by the UE 10#1.

After the beam selection, the UE 10 may further estimate the precoded channel and report the CSI of the selected beam together with its CSI-RS pattern index and the group index. The narrow beam is sensitive to the mobility. Even if the UE 10 is moving among the beams, the conventional handover procedure is not needed for the virtual beam cell reselection. The designed CSI-RS enables fast beam selection and CSI estimation at the same time. The UE 10 may report multiple sets of CSI reporting corresponding to current selected beam and the target beam(s).

Some of the parameters in the CSI-RS pattern configuration for the virtual beam cells in Sect. 5.2.1 assist the CSI-RS pattern detection and beam-specific CSI measurement. According to the ZP-CSI-RS Subframe Configuration (I_ZP-CSI-RS), the UEs 10 may find the subframe/slot to detect the CSI-RS pattern with ZP-CSI-RS. If the periodicity of ZP-CSI-RS (T_ZP-CSI-RS) is longer than that of CSI-RS (T_CSI-RS), the beam pattern detection is carried out less frequently than that of CSI measurement updates. Also, in the frequency domain, the ZP-CSI-RS subband configuration as well as the RB allocation mode for ZP-CSI-RS may be indicated to narrow down the searching bandwidth and reduce the detection complexity. For example, if the RB allocation mode of ZP-CSI-RS is contiguous RB allocation, the UE 10 may refer to the ZP-CSI-RS subband configuration to find the searching range and narrow down the number of the RBs with the ZP-CSI-RS. If the RB allocation mode of ZP-CSI-RS is distributed RB allocation, the UE 10 may refer to the number of beams on each antenna port and the Number of RBs for the ZP-CSI-RS per beam to detect the equally distributed RBs of ZP-CSI-RS to detect/select the beams per antenna port over the whole bandwidth or partial subband. The network may indicate the subband or RBs of ZP-CSI-RS RUs for several selected beam cells and let UEs 10 only detect those selected beam cells for measurement update or no measurement update.

As for the Threshold setting, there are many options. One option is network-controlled and the configured Threshold informed to the UEs 10 could be user-specific, beam-specific, or cell-specific. It assists the network to control the load balancing in each virtual beam cell. Too high Threshold will result in that many RUs are low-energy and no beam is selected due to the unidentified CSI-RS pattern although there are many UEs 10 in the BS 20 coverage. The network may adjust the relative threshold by Th_{delta} adaptive to the UE 10 distribution and system traffic load to offload the traffic to the virtual beam cells at higher frequency band. Another option is to let UEs 10 locally decide their Threshold. One method is to set a relative level ‘Δ’ lower than the highest average received signal, such as Th=max{Λ[n]}−Δ, or a relative level ‘Δ’ higher than the estimated average noise power, as Th=δₙ²−Δ.

Thus, according to one or embodiments of the first example of the present invention, the UE 10 may detect the beam(s) using transmission power information indicating the transmission power level (value) applied to the CSI-RS.

(User Feedback Based on Beam-Specific CSI-RS Patterns)

Based on the beam-specific CSI-RS patterns, the following higher-layer parameters indicated to the UEs 10 for the network-controlled user feedback or reporting may include:
Max number of selected beam(s) (beam number): 1, 2, . . . .
Feedback mode: Periodic or Aperiodic
Feedback configuration of large-scale RRM measurement
   On/Off
   Periodicity (in case of periodic reporting)
   RSRP or large-scale beam gain against RSRP without beam forming
   RSRQ or the large-scale beam gain against RSRQ without beam forming
Feedback configuration of small-scale CSI measurement
   On/Off
   Periodicity (in case of periodic reporting)
   CSI feedback mode of each selected CSI-RS pattern
      CQI: channel quality indicator (wideband or subband)
      PMI: precoding matrix indicator (wideband or subband)
      RI: rank indicator (wideband or subband)
      CRI: CSI-RS resource indicator (wideband or subband) to indicate the beam that the UEs 10 prefers in case that the UE 10 is configured to monitor multiple beams
Allocated resource configuration for feedback of the selected beam(s) or CSI-RS pattern(s)
   Allocated subband(s)
   Allocated subframe(s)

According to the higher-layer parameters of the User feedback based on beam-specific CSI-RS patterns, the feedback from each UE 10 is illustrated as:
Number of selected beam(s) (beam number): 1, 2, . . . .
Index of selected beam(s) or selected CSI-RS pattern(s): (port index, beam index per port)
   CSI-RS pattern index, RB index or relative RB index of the ZP-CSI-RS as the beam index per port
Feedback of large-scale RRM measurement (if On)
   RSRP of each selected beam or the large-scale beam gain against RSRP without beam forming
   RSRQ of each selected beam or the large-scale beam gain against RSRQ without beam forming
Feedback of small-scale CSI measurement (if On)
   CSI feedback each selected CSI-RS pattern
      CQI: channel quality indicator (wideband or subband)
      PMI: precoding matrix indicator (wideband or subband)
      RI: rank indicator (wideband or subband)
      CRI: CSI-RS resource indicator (wideband or subband)

Thus, according to one or embodiments of the first example of the present invention, the UE 10 may transmit feedback information indicating the detected beam(s) based on beam-specific CSI-RS patterns to the BS 20.

(Beam Switch Based on Beam-Specific CSI-RS Patterns)

The narrow beams are used to improve the received signal power of the UEs 10. However, narrower beams are more sensitive to the user mobility. If a mobile UE 10 is moving from the coverage of one narrow beam cell to another, it is necessary for the UE 10 to reselect the beam(s) to avoid the data rate degradation.

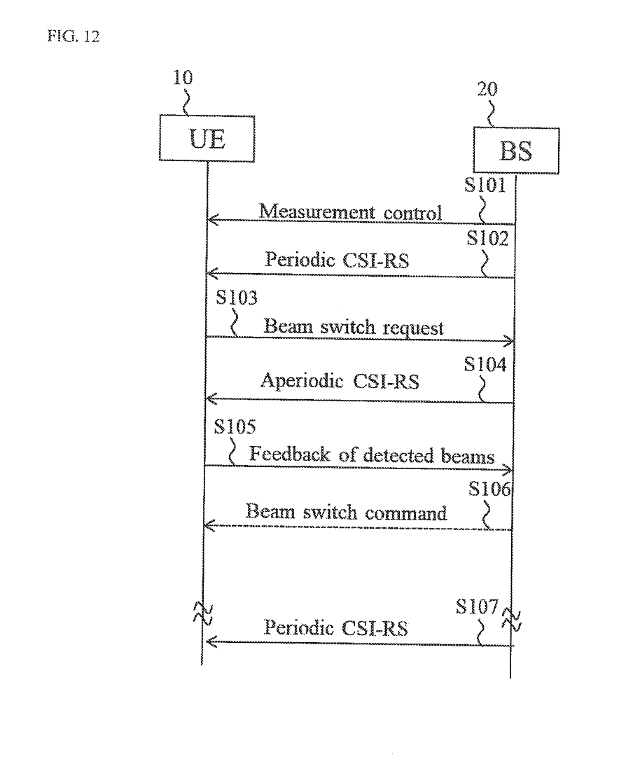

An example is given in FIG. 11, where UE 10#1 is moving from the coverage of the beam 2 in group 1 to that of the beam 2 in group2. In an example operation of FIG. 12, at step S101, the BS 20 may transmit measurement control to the UE 10, and then, at step S102, the BS 20 may transmit the periodic CSI-RS(s). At step S103, the UE 10 may transmit the beam switch request to the BS 20. At step S104, the BS 20 may transmit the aperiodic CSI-RS(s). At step S105, the UE 10 may transmit feedback information indicating the detected beam(s). At step S106, the BS 20 may transmit a beam switch command. At step S107, the BS 20 may transmit the periodic CSI-RS(s). When the UE 10#1 finds out the received power on the NZP-CSI-RS RUs of the current source beam, the beam 2 in group1 (with CSI-RS sent on antenna port 15), is getting weaker than a defined Trigger threshold (Trigger_Thr), the UE 10#1 may send a beam switch request, for example in the physical uplink control channel (PUCCH), to trigger the BS 20 send the aperiodic CSI-RS transmission, which is shown in the procedure of FIG. 12. Meanwhile, the UE 10#1 detects the received power on the NZP-CSI-RS RUs of the beam 2 in group2 (with CSI-RS sent on antenna port 16) is increasing. Until the received power on the NZP-CSI-RS RUs of the beam 2 in group2 is higher than a threshold (Thr) for beam detection, the UE 10#1 will send the beam 2 in group2 as a candidate target beam. A UE 10 may have more than one beam if the received power of the beam-specific NZP-CSI-RS RUs are higher than the pre-defined Thr but the low-power is on the corresponding ZP-CSI-RS RU(s).

Both Trigger_Thr and Thr as well as the max number of the detected beams for feedback are network-controlled and may be included in the higher-layer parameters for beam-specific CSI-RS patterns, given as:
Threshold for NZP/ZP-CSI-RS (Thr) (if network-controlled)
Threshold to trigger aperiodic beam-specific CSI-RS transmission (Trigger_Thr) (if network-controlled)
Max number of detected beams (beam number): 1, 2, . . . .

As illustrated in FIG. 11, the Trigger_Thr is set slightly higher than the Thr in order to trigger the aperiodic CSI-RS transmission earlier and the beam switch procedure is based on the measurement/feedback of aperiodic CSI-RS transmission, which is more flexible than periodic CSI-RS transmission. The feedback of more than one beam allows the UE 10 to be communicating with both source beam and target beam during switch, making it a soft beam switch. Based on the above parameters, the UE 10 reports the following illustrated information of selected beam(s) among the candidate target beam(s).
Number of selected beam(s) (beam number): 1, 2, . . . .
Index of selected beam(s) or selected CSI-RS pattern(s): (port index, beam index per port)
   CSI-RS pattern index, RB index or relative RB index of the ZP-CSI-RS as the beam index per port
Feedback of large-scale RRM measurement (if On)
   RSRP of each selected beam or the large-scale beam gain against RSRP without beam forming
   RSRQ of each selected beam or the large-scale beam gain against RSRQ without beam forming
Feedback of small-scale CSI measurement (if On)
   CSI feedback each selected CSI-RS pattern
      CQI: channel quality indicator (wideband or subband)
      PMI: precoding matrix indicator (wideband or subband)
      RI: rank indicator (wideband or subband)
      CRI: CSI-RS resource indicator (wideband or subband)

The network may control the beam switch. In additional to the higher-layer parameters, the lower-layer signaling such as that on physical downlink control channel (PDCCH) may be used to instantaneously indicate/select the parameters of aperiodic CSI-RS. For example, between the source beam and target beam, the 1-bit indication in PDCCH is used for instantaneous beam switch command. Also, it is possible to use more than one bit in PDCCH, such as using 2-bit indication to choose the target beam among max 4 configured candidate beams for aperiodic CSI-RS. According to the network-controlled signals, the corresponding user behavior is adjusted for the RRM/CSI measurement of the serving beams, i.e., reset the CSI average filtering if beam switching. The duration of the aperiodic CSI-RS is adaptive to the UE 10 mobility, but may be controlled by the network based on the feedback of the detected beams, such as configuring the signaling to set the duration or indicate start/end timing of the aperiodic CSI-RS.

### Second Example

(Beam-Specific CSI-RS Pattern Configuration)

According to one or more embodiments of a second example of the present invention, the BS 20 may generate a CSI-RS that is quasi-orthogonally or non-orthogonally multiplexed on multiple REs and transmit the CSI-RS tot the UE 10. For example, the BS 20 may scramble the multiple REs on which the CSI-RS is multiplexed with a predetermined scrambling sequence. For example, the BS 20 may notify the UE 10 of scrambling sequence information that indicates the predetermined scrambling sequence.

One or more embodiments of the second example of the present invention introduce the beam-specific CSI-RS pattern with different scrambling sequences. Assuming the basic CSI-RS sequence r_{l,n}(m) is defined in Sect. 6.10.5.1 of TS36.211 as

$${r}_{l , {n}_{s}} ( m ) = \frac{1}{\sqrt{2}} ( 1 - 2 \cdot c ( 2 m ) ) + j \frac{1}{\sqrt{2}} ( 1 - 2 \cdot c ( 2 m + 1 ) ) , \\ m = 0 , 1 , … , {N}_{RB}^{max , DL} - 1$$

where nₛ is the slot number within a radio frame and l is the OFDM symbol number within the slot. The pseudo-random sequence c(i) is defined in Sect. 7.2 of TS36.211. The pseudo-random sequence generator shall be initialized with

cᵢₙᵢₜ=2¹⁰·(7·(n′ₛ+1)+l+1)·(2·N_{ID}^{CSI}+1)+2·N_{ID}^{CSI}+N_{CP},

at the start of each OFDM symbol where the quantity N_{ID}^{CSI} equals N_{ID}^{cell} unless configured by higher layers and

$${n}_{s}^{′} = \{ \begin{matrix}10 ⌊ {n}_{s} / 10 ⌋ + {n}_{s} mod 2 & \begin{matrix}for frame structure type 3 when \\ the CSI \text{-} RS is part of a DRS\end{matrix} \\ {n}_{s} & otherwise\end{matrix} \\ {N}_{CP} = \{ \begin{matrix}1 & for normal CP \\ 0 & for extended CP\end{matrix}$$

Besides the PN sequence, other sequences with good auto-/cross-correlation characteristics may also be used, such as Barker sequence, Gold sequence, etc.

The a block of CSI-RS bits r(0), . . . , r(N_{RB}^{max,DL}−1), is scrambled with a beam-specific sequence, resulting in a block of scrambled CSI-RS bits \tilde{r}(0), . . . , \tilde{r}(N_{RB}^{max,DL}−1) according to

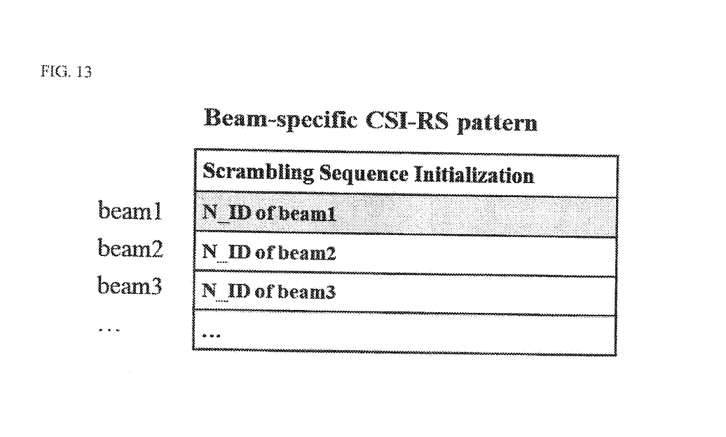

\tilde{r}(i)=(r(i)+s(i))mod 2

where the scrambling sequence s(i) is defined by a length-31 Gold sequence. The scrambling sequence shall be initialized with sᵢₙᵢₜ=N_{ID}^{beam}. The beam-specific CSI-RS pattern with different scrambling sequences is illustrated by using beam-specific scrambling sequence initialization as in FIG. 13.

The periodic CSI-RS has already been supported in LTE Release 10, where the eNB/BS 20 will inform the RRC signaling related to the CSI-RS parameters to the RRC-connected UEs 10, illustrated as:
CSI-RS state: On/off
CSI-RS sequence generation based on cell ID
CSI-RS total bandwidth in terms of number of RBs
CSI-RS power: −60.00-200.00 dB
Number of CSI-RS antenna ports: 1/2/4/8/12/16
CSI-RS Antenna Port: port 15/port15-16/port15-18/port15-22/port15-26/port15-30
CSI-RS Configuration:
   Table 6.10.5.2-1 in TS36.211 for normal cyclic prefix
   Table 6.10.5.2-2 in TS36.211 for extended cyclic prefix
CSI-RS Subframe Configuration (I_CSI-RS): 0-154
   The CSI-RS Subframe Configuration index which defines both the CSI-RS Periodicity (T_CSI-RS) and the CSI-RS Subframe Offset parameters (Delta_CSI-RS). Subframes containing CSI reference signals shall satisfy: (10SFN+Floor(Slot#/2)-Delta_CSI-RS)mod T_CSI-RS=0 with
      I_CSI-RS=0 to 4, T_CSI-RS=5, Delta_CSI-RS=I_CSI-RS
      I_CSI-RS=5 to 14, T_CSI-RS=10, Delta_CSI-RS=I_CSI-RS-5
      I_CSI-RS=15 to 34, T_CSI-RS=20, Delta_CSI-RS=I_CSI-RS-15
      I_CSI-RS=35 to 74, T_CSI-RS=40, Delta_CSI-RS=I_CSI-RS-35
      I_CSI-RS=75 to 154, T_CSI-RS=80, Delta_CSI-RS=I_CSI-RS-75

By adapting the proposed beam-specific CSI-RS patterns, the higher-layer (RRC) CSI-RS parameters should include the parameters for beam-specific CSI-RS pattern. This beam-specific CSI-RS can be used for DL beam detection/selection and/or DL beam CSI estimation. Especially, the parameters of beam-specific CSI-RS pattern are required to let UEs 10 carry out beam detection/selection based on energy detection by identifying the CSI-RS pattern of the strongest virtual beam cell.

The CSI-RS parameters for beam detection/selection may be only used for RRM measurement of large-scale fading and beam gain instead of small-scale fading. In order to let UEs 10 select the best beam(s) based on simultaneous transmission of a larger number of beam-specific CSI-RS, the eNB/BS 20 may focus the limited CSI-RS transmit power on a narrow subband as the configured CSI-RS bandwidth and distribute the transmit power on the simultaneously-transmitted CSI-RSs. The longer scrambling sequences are more robust against the noise and interference, which is helpful to identify the beam-specific CSI-RS pattern at the receiver side.

Therefore, for beam detection/selection, additional higher-layer parameters of beam-specific CSI-RS patterns are required, illustrated as:
CSI-RS scrambling On/Off
CSI-RS scrambling sequence generation based on beam IDs
Number of beams on each CSI-RS port (N_Beam_Per_Port): 0, 1, . . . .
Threshold for correlation detection of scrambling sequence (Thr) (if network-controlled)
Threshold to trigger aperiodic beam-specific CSI-RS transmission (Trigger_Thr) (if network-controlled)

Each UE 10 relies on the blind detection of correlation to find out the beam ID of the beam-specific CSI-RS sequences to select the proximate virtual beam cell(s).

Besides the periodic CSI-RS transmission, it is also useful to configure aperiodic CSI-RS transmission to reselect the virtual beam cell(s) and/or aperiodic CSI feedback/reporting, especially in case that a mobile UE 10 is moving from one narrow beam cell to another narrow beam cell. The aperiodic CSI-RS transmission may be triggered by a UE 10, when the UE 10 finds out the scrambling sequence correlation of the current beam cell is weaker than a threshold (details in Sect. 5.3.4). The UE 10#1 may send a request to ask BS 20/eNB send the aperiodic CSI-RS. The network may configure to send the CSI-RS of several beam cells, which are close to the current beam cells, as candidate target beam cells.

(Beam-Specific CSI-RS Pattern Detection)

By using the defined CSI-RS patterns, the UE 10 can locally carry out the cross-correlation between each beam-specific scrambling sequences and the received CSI-RS sequence to identify whether it is in the coverage of any beam with strong cross-correlation peak. If it detects the strong beam, the UE 10 can further identify the beam index according to the corresponding scrambling sequence initialization index.

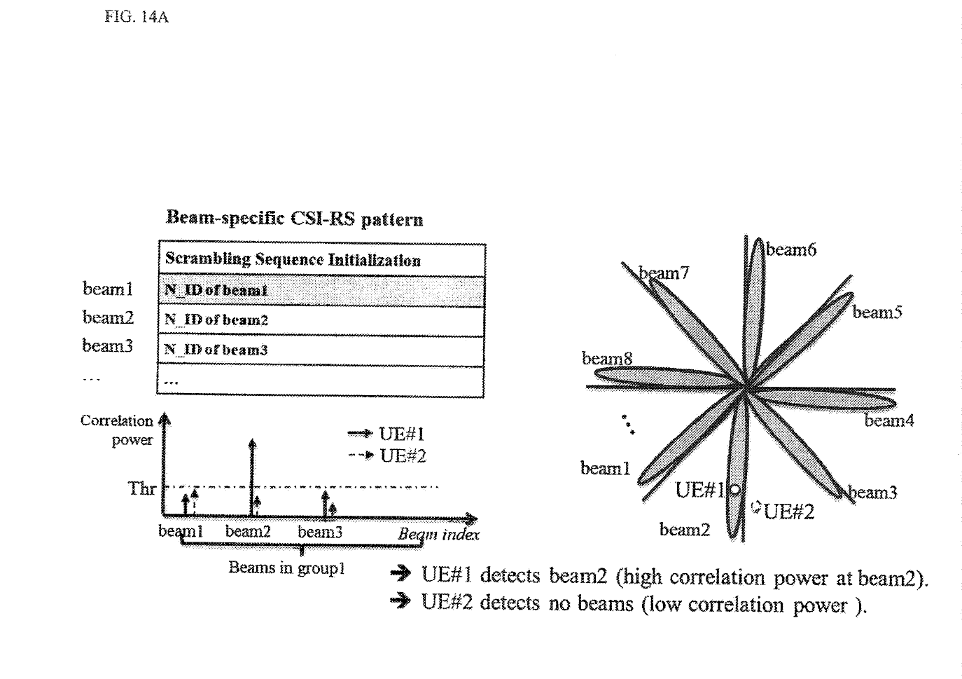

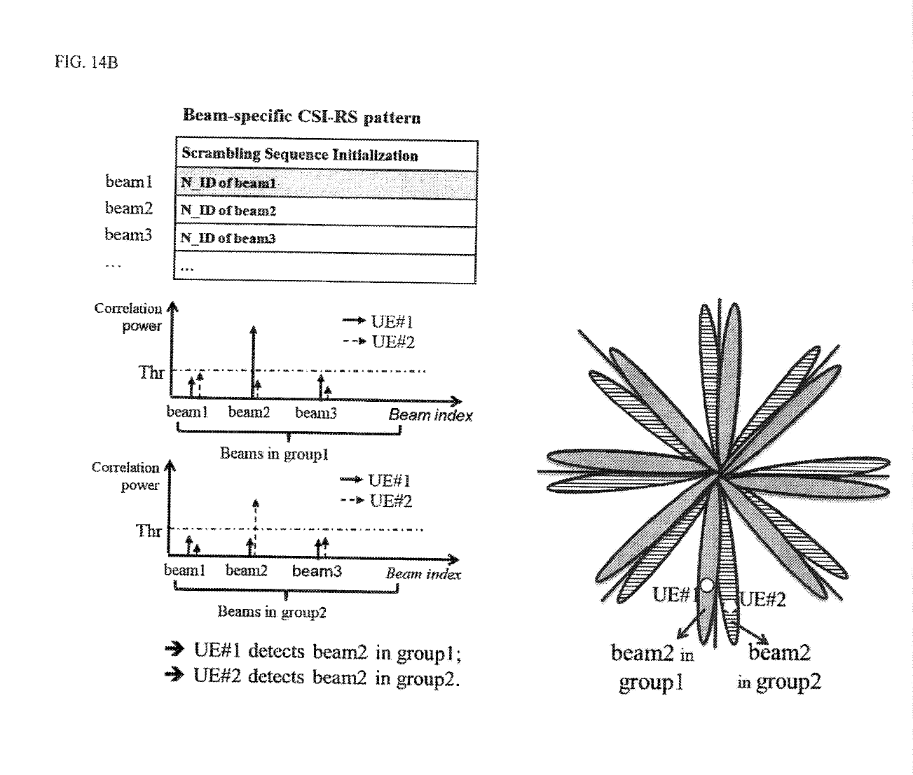

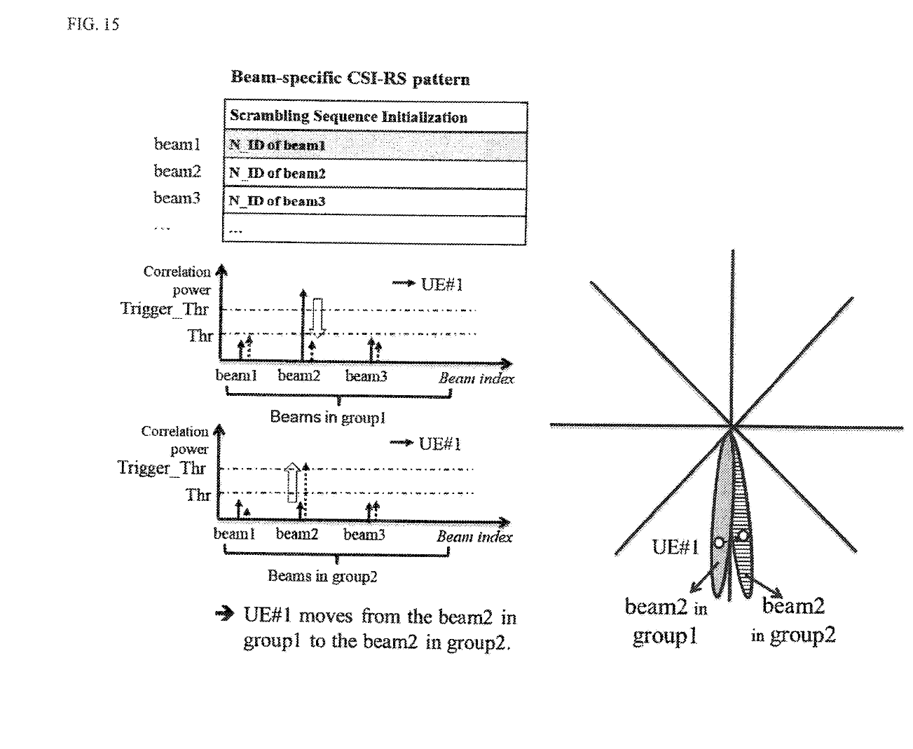

An example is shown in FIG. 14A, where UE 10#1 is within the coverage of beam 2 in group 1. The UE 10#1 finds out the cross-correlation peak at the beam 2 in group 1 only. Accordingly, the UE 10#1 selects the beam 2 in group 1. However, the UE 10#2 is out of the coverage of all the beams in group 1. The cross-correlation power of all the beams is lower than the Threshold so that no beam in group 1 is selected. In FIG. 14B, the UE 10#2 is in the beam 2 of group2, but UE 10#1 is not. In the same way, the UE 10#2 finds out the unique cross-correlation peak at beam 2 in group2 and the beam 2 in group2 is selected according to the beam 2 CSI-RS pattern configuration. But no beam in group2 is selected by the UE 10#1.

After the beam selection, the UE 10 may further estimate the precoded channel and report the CSI of the selected beam together with its CSI-RS pattern index and the group index. The narrow beam is sensitive to the mobility. Even if the UE 10 is moving among the beams, the conventional handover procedure is not needed for the virtual beam cell reselection. The designed CSI-RS enables fast beam selection and CSI estimation at the same time. The UE 10 may report multiple sets of CSI reporting corresponding to current selected beam and the target beam(s).

As for the Threshold setting, there are many options. One option is network-controlled and the configured Threshold informed to the UEs 10 could be user-specific, beam-specific, or cell-specific. It assists the network to control the load balancing in each virtual beam cell. Too high Threshold will result in that no beam is selected due to the unidentified CSI-RS pattern although there are many UEs 10 in the BS 20 coverage. The network may adjust the relative threshold by Thr_{delta} adaptive to the UE 10 distribution and system traffic load to offload the traffic to the virtual beam cells at higher frequency band. Another option is to let UEs 10 locally decide their Threshold.

Thus, according to one or embodiments of the second example of the present invention, the UE 10 may detect the beam(s) using the scrambling sequence used for the scrambled REs mapped to the CSI-RS.

(User Feedback Based on Beam-Specific CSI-RS Patterns)

Based on the beam-specific CSI-RS patterns, the following higher-layer parameters indicated to the UEs 10 for the network-controlled user feedback or reporting may include:
Max number of selected beam(s) (beam number): 1, 2, . . . .
Feedback mode: Periodic or Aperiodic
Feedback configuration of large-scale RRM measurement
   On/Off
   Periodicity (in case of periodic reporting)
   RSRP or large-scale beam gain against RSRP without beam forming
   RSRQ or the large-scale beam gain against RSRQ without beam forming
Feedback configuration of small-scale CSI measurement
   On/Off
   Periodicity (in case of periodic reporting)
   CSI feedback mode of each selected CSI-RS pattern
      CQI: channel quality indicator (wideband or subband)
      PMI: precoding matrix indicator (wideband or subband)
      RI: rank indicator (wideband or subband)
      CRI: CSI-RS resource indicator (wideband or subband)
         to indicate the beam that the UEs 10 prefers in case that the UE 10 is configured to monitor multiple beams
Allocated resource configuration for feedback of the selected beam(s) or CSI-RS pattern(s)
   Allocated subband(s)
   Allocated subframe(s)

According to the higher-layer parameters of the User feedback based on beam-specific CSI-RS patterns, the feedback from each UE 10 is illustrated as:
Number of selected beam(s) (beam number): 1, 2, . . . .
Index of selected beam(s) or selected CSI-RS pattern(s): (port index, beam index per port)
   CSI-RS pattern index, Scrambling initialization index or the beam index per port
Feedback of large-scale RRM measurement (if On)
   RSRP of each selected beam or the large-scale beam gain against RSRP without beam forming
   RSRQ of each selected beam or the large-scale beam gain against RSRQ without beam forming
Feedback of small-scale CSI measurement (if On)
   CSI feedback each selected CSI-RS pattern
      CQI: channel quality indicator (wideband or subband)
      PMI: precoding matrix indicator (wideband or subband)
      RI: rank indicator (wideband or subband)
      CRI: CSI-RS resource indicator (wideband or subband)

Thus, according to one or embodiments of the second example of the present invention, the UE 10 may transmit feedback information indicating the detected beam(s) based on beam-specific CSI-RS patterns to the BS 20.

(Beam Switch Based on Beam-Specific CSI-RS Patterns)

The narrow beams are used to improve the received signal power of the UEs 10. However, narrower beams are more sensitive to the user mobility. If a mobile UE 10 is moving from the coverage of one narrow beam cell to another, it is necessary for the UE 10 to reselect the beam(s) to avoid the data rate degradation.

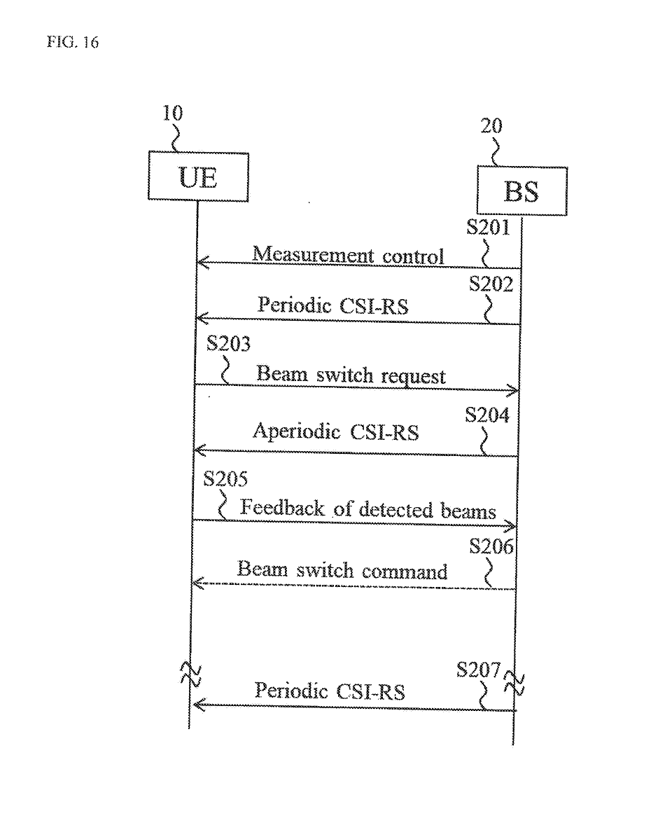

An example is given in FIG. 15, where UE 10#1 is moving from the coverage of the beam 2 in group 1 to that of the beam 2 in group2. Steps S201-S207 in FIG. 16 are similar to the steps S101-S107 in FIG. 12. When the UE 10#1 finds out the cross-correlation peak of the current source beam, the beam 2 in group1 (with CSI-RS sent on antenna port 15), is getting weaker than a defined Trigger threshold (Trigger_Thr), the UE 10#1 may send a beam switch request, for example in the physical uplink control channel (PUCCH), to trigger the BS 20/eNB send the aperiodic CSI-RS transmission, which is shown in the procedure of FIG. 12. Meanwhile, the UE 10#1 detects the cross-correlation peak of the beam 2 in group2 (with CSI-RS sent on antenna port 16) is increasing. Until the correlation peak of the beam 2 in group2 is higher than a threshold (Thr) for beam detection (as described in Sect. 5.3.2), the UE 10#1 will send the beam 2 in group2 as a candidate target beam. A UE 10 may have more than one beam if their correlation peaks are higher than the pre-defined Thr.

Both Trigger_Thr and Thr as well as the max number of the detected beams for feedback are network-controlled and may be included in the higher-layer parameters for beam-specific CSI-RS patterns, given as:
Threshold for correlation peak (Thr) (if network-controlled)
Threshold to trigger aperiodic beam-specific CSI-RS transmission (Trigger_Thr) (if network-controlled)
Max number of detected beams (beam number): 1, 2, . . . .

As illustrated in FIG. 15, the Trigger_Thr is set slightly higher than the Thr in order to trigger the aperiodic CSI-RS transmission and the beam switch procedure is based on the measurement/feedback of both source beam and target beam. This allows the UE 10 to be communicating with both source beam and target beam during switch, making it a soft beam switch. Based on the above parameters, the UE 10 reports the following illustrated information of selected beam(s) among the candidate target beam(s).
Number of selected beam(s) (beam number): 1, 2, . . . .
Index of selected beam(s) or selected CSI-RS pattern(s): (port index, beam index per port)
   CSI-RS pattern index, RB index or relative RB index of the ZP-CSI-RS as the beam index per port
Feedback of large-scale RRM measurement (if On)
   RSRP of each selected beam or the large-scale beam gain against RSRP without beam forming
   RSRQ of each selected beam or the large-scale beam gain against RSRQ without beam forming
Feedback of small-scale CSI measurement (if On)
   CSI feedback each selected CSI-RS pattern
      CQI: channel quality indicator (wideband or subband)
      PMI: precoding matrix indicator (wideband or subband)
      RI: rank indicator (wideband or subband)
      CRI: CSI-RS resource indicator (wideband or subband)

In additional to the higher-layer parameters, the lower-layer signaling such as that on physical downlink control channel (PDCCH) may be used to instantaneously indicate/select the parameters of aperiodic CSI-RS. For example, between the source beam and target beam, the 1-bit indication in PDCCH is used for instantaneous beam switch command. Also, it is possible to use more than one bit in PDCCH, such as using 2-bit indication to choose the target beam among max 4 configured candidate beams for aperiodic CSI-RS. According to the network-controlled signals, the corresponding user behavior is adjusted for the RRM/CSI measurement of the serving beams, i.e., reset the CSI average filtering if beam switching. The duration of the aperiodic CSI-RS is adaptive to the UE 10 mobility but may be controlled by the network based on the feedback of the detected beams, such as configuring the signaling to set the duration or indicate start/end timing of the aperiodic CSI-RS.

Embodiments of the invention have one or more of the following advantages with respect to the state-of-the-art network densification approaches:
Increase the multiplexed CSI-RS for a large number of virtual beam cells over the same antenna CSI-RS ports with no additional overhead.
Network achieve the user location based the user-detected beam pattern.
The configured precoded beams, sharing the same cell ID, are transparent to the UEs 10.
No handover for the mobile UEs 10 to change the virtual beam cells with the same cell ID.
User equipment only feeds back the index of the identified CSI-RS beam pattern if within the corresponding virtual beam cell coverage.
No additional feedback of the RRM measurement (RSRP/RSRQ) to network for different virtual beam cells.
The CSI feedback overhead is only related to the user-selected beam cell but independent of the eNB/BS 20 transmit antenna numbers.
The CSI-RS design for virtual beam cells has good backward compatibility to the LTE DL CSI-RS.
The simultaneous transmission of DL CSI-RS for the virtual beam cells is already synchronized at the co-located BS 20.
DL CSI-RS transmission does not need power control as needed for UL RS from different UEs 10.

Some portions of the detailed descriptions above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments of the present invention also relate to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMS), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

A machine-readable medium includes any mechanism for storing or transmitting information in a form readable by a machine (e.g., a computer). For example, a machine-readable medium includes read only memory (“ROM”); random access memory (“RAM”); magnetic disk storage media; optical storage media; flash memory devices; electrical, optical, acoustical or other form of propagated signals (e.g., carrier waves, infrared signals, digital signals, etc.); etc.

Although the present disclosure mainly described examples of a channel and signaling scheme based on NR, the present invention is not limited thereto. One or more embodiments of the present invention may apply to another channel and signaling scheme having the same functions as NR such as LTE/LTE-A and a newly defined channel and signaling scheme.

Although the present disclosure mainly described examples of technologies related to channel estimation and CSI feedback schemes based on the CSI-RS, the present invention is not limited thereto. One or more embodiments of the present invention may apply to another synchronization signal, reference signal, and physical channel such as Primary Synchronization Signal/Secondary Synchronization Signal (PSS/SSS) and DM-RS.

Although the present disclosure described examples of various signaling methods, the signaling according to one or more embodiments of the present invention may be explicitly or implicitly performed.

Although the present disclosure mainly described examples of various signaling methods, the signaling according to one or more embodiments of the present invention may be higher layer signaling such as RRC signaling and/or lower layer signaling such as Down Link Control Information (DCI) and Media Access Control Control Element (MAC CE). Furthermore, the signaling according to one or more embodiments of the present invention may use a Master Information Block (MIB) and/or a System Information Block (SIB). For example, at least two of the RRC, the DCI, and the MAC CE may be used in combination as the signaling according to one or more embodiments of the present invention.

In one or more embodiments of the present invention, the frequency (frequency-domain) resource, a Resource Block (RB), and a subcarrier in the present disclosure may be replaced with each other. The time (time-domain) resource, a subframe, a symbol, and a slot may be replaced with each other.

The above examples and modified examples may be combined with each other, and various features of these examples can be combined with each other in various combinations. The invention is not limited to the specific combinations disclosed herein.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

What is claimed is:

1. A method for wireless communication, the method comprising:
transmitting, from a base station (BS) to a user equipment (UE), a Channel State Information Reference Signal (CSI-RS),
wherein the CSI-RS is quasi-orthogonally or non-orthogonally multiplexed on multiple resource elements (REs).

2. The method according to claim 1,
wherein the transmitting transmits multiple CSI-RSs, and
wherein the multiple CSI-RSs are multiplexed on a same RE or same REs.

3. The method according to claim 1, further comprising:
applying, with the BS, different transmission power to the multiple REs.

4. The method according to claim 3, further comprising:
notifying, with the BS, the UE of transmission power information that indicates values of the applied different transmission power.

5. The method according to claim 3, further comprising:
wherein the applying applies zero-power (ZP) to part of the multiple REs.

6. The method according to claim 1, further comprising:
scrambling, with the BS, the multiple REs with a predetermined scrambling sequence.

7. The method according to claim 6, further comprising:
notifying, with the BS, the UE of scrambling sequence information that indicates predetermined scrambling sequence.

8. The method according to claim 3, further comprising:
scrambling, with the BS, the multiple REs with a predetermined scrambling sequence.

9. The method according to claim 8, further comprising:
notifying, with the BS, the UE of scrambling sequence information that indicates predetermined scrambling sequence.

10. The method according to claim 4, further comprising:
scrambling, with the BS, the multiple REs with a predetermined scrambling sequence.

11. The method according to claim 10, further comprising:
notifying, with the BS, the UE of scrambling sequence information that indicates predetermined scrambling sequence.

12. The method according to claim 4,
wherein the transmitting transmits multiple CSI-RSs using different beams, and
the method further comprising:
detecting, with the UE, at least one beam of the different beams using the transmission power information.

13. The method according to claim 12, further comprising:
transmitting, from the UE to the BS, feedback information that indicates the detected beam.

14. The method according to claim 7,
wherein the transmitting transmits multiple CSI-RSs using different beams, and
the method further comprising:
detecting, with the UE, at least one beam of the different beams using the scrambling sequence information.

15. The method according to claim 14, further comprising:
transmitting, from the UE to the BS, feedback information that indicates the detected beam.

16. The method according to claim 11,
wherein the transmitting transmits multiple CSI-RSs using different beams, and
the method further comprising:
detecting, with the UE, at least one beam of the different beams using the transmission power information and the scrambling sequence information.

17. The method according to claim 16, further comprising:
transmitting, from the UE to the BS, feedback information that indicates the detected beam.

18. A user equipment (UE) comprising:
a receiver that receives, from a base station (BS):
multiplexing information; and
multiple Channel State Information Reference Signals (CSI-RSs) using different beams; and
a processor that detects at least one beam of the different beams based on the multiplexing information,
wherein the multiple CSI-RSs are quasi-orthogonally or non-orthogonally multiplexed on multiple resource elements (REs), and
wherein the multiplexing information indicates a quasi-orthogonal multiplexing method or a non-orthogonal multiplexing method used for multiplexing the multiple CSI-RSs.

19. The UE according to claim 18, further comprising:
a transmitter that transmits, to the BS, feedback information that indicates the detected beam.

20. A user equipment (UE) comprising:
a processor that detects, based on multiplexing information transmitted from a base station (BS), at least one beam of different beams used for multiple Channel State Information Reference Signals (CSI-RSs) transmission; and
a transmitter that transmits, to the BS, feedback information that indicates the detected beam,
wherein the multiple CSI-RSs are quasi-orthogonally or non-orthogonally multiplexed on multiple resource elements (REs), and
wherein the multiplexing information indicates a quasi-orthogonal multiplexing method or a non-orthogonal multiplexing method used for multiplexing the multiple CSI-RSs.
